(19) United States
(12) Patent Application Publication
(10) Pub. No.: US 2026/0261685 A1
(43) Pub. Date: Sep. 3, 2026

(54) METHODS AND SYSTEMS FOR MAINTAINING LEGIBILITY IN MEDIA CONTENT

(71) Applicant: Adeia Guides Inc., San Jose, CA (US)

(72) Inventor: Ning Xu, Irvine, CA (US)

(21) Appl. No.: 19/067,418

(22) Filed: Feb. 28, 2025

(51) Int. Cl. H04N 19/154; H04N 19/167; H04N 19/17; H04N 19/189; H04N 19/50

(52) U.S. Cl. CPC H04N 19/154; H04N 19/167; H04N 19/17; H04N 19/189; H04N 19/50

(57) ABSTRACT

Systems and methods are described for providing a text or symbol legibility prediction for use in encoding one or more video frames. Video frame data is received, the video frame data characterizing one or more video frames of a video comprising at least one symbol. One or more encoding parameters are received, the one or more encoding parameters for encoding the one or more video frames. A legibility score for the symbol(s) of the video frame(s) is determined based on the received video frame data and the one or more encoding parameters. The legibility score indicates a legibility of the symbol(s) when the video frame(s) are encoded using the one or more encoding parameters and then decoded. At least one of the received video frame data or the encoding parameters is modified based on the legibility score in order to help maintain legibility of the symbol(s) when the video frame(s) are decoded for rendering.

### BACKGROUND

The present disclosure relates to methods and systems for predicting legibility of symbols or visual elements depicted in media content (e.g., video), when the media content is decoded and one or more visual elements in the media are rendered for display. More particularly, but not exclusively, the present disclosure relates to using video frame data and encoding parameters to balance efficient storage and transmission of the media content while maintaining legibility of symbols and visual elements through video encoding, decoding, and rendering processes.

### SUMMARY

Video encoding is a critical process in the storage and transmission of digital video content. It involves compressing raw video data to reduce the amount of storage or bandwidth required, while aiming to preserve sufficient quality for the intended use. Modern video encoding algorithms typically achieve compression by exploiting redundancies within and between video frames, as well as by quantizing data to represent it more efficiently. The degree of compression applied may, however, directly impact the quality of the decoded video frames, leading to a trade-off between compression efficiency and visual fidelity.

Compression artefacts, such as blurring, blocking, or color banding, may emerge when the compression ratio is increased, particularly in regions of the video with complex textures or rapid motion. These artefacts can degrade the interpretability of visual information in the decoded frames, which adversely impacts comprehension of and engagement with many types of media content, and which may be especially critical in applications requiring precise visual analysis, such as medical imaging, video surveillance, or autonomous systems. Consequently, achieving an effective or optimal balance between file size and visual clarity is a fundamental challenge in video encoding.

To address this challenge, current methods often include adaptive compression techniques, where the encoding process dynamically adjusts based on the characteristics of the video content. For example, more bits may be allocated to high-detail or high-motion areas, while smoother or static regions are compressed more aggressively. Additionally, advanced encoding standards, such as H.265/HEVC and AV1, employ sophisticated prediction and transformation techniques to enhance compression efficiency without significantly compromising quality. Techniques like perceptual optimization may further improve visual clarity by aligning encoding decisions with human visual perception, prioritizing the preservation of visually important features such as edges, textures, and motion.

Adaptive bitrate (ABR) streaming is a method employed to optimize video delivery over varying network conditions. By dynamically adjusting the quality of the video stream to match the user's available bandwidth and device capabilities, ABR aims to ensure a smoother viewing experience while minimizing buffering. This approach involves encoding a video at multiple quality levels and segmenting it into small chunks, typically a few seconds long. During playback, the streaming client monitors network performance and switches between these chunks to provide the highest possible quality without interruption. ABR leverages real-time feedback mechanisms to balance bitrate, resolution, and frame rate, potentially reducing the likelihood of playback stalling in low-bandwidth conditions while maintaining visual clarity wherever possible. This technique has become a cornerstone of modern video delivery platforms, enabling consistent performance across diverse devices and network environments.

The relationship between compression settings, quality metrics, and human interpretability is not always linear, and optimizing one aspect can adversely affect others. Despite these advancements, therefore, limitations may remain in scenarios where the video content contains visual elements or symbols, which may be particularly affected by compression artefacts. In these scenarios, the benefits of higher compression may be outweighed by the loss of visual or contextual information. This ongoing trade-off highlights the need for further innovation in video encoding techniques, particularly in improving the interpretability of visual elements or information in compressed video streams.

Systems and methods are described for determining, estimating, or predicting whether video coding parameters (e.g., bitrate, resolution, compression levels, among others), when taken in combination with one or more visual properties of video frames comprising symbols, have a likelihood of causing legibility issues when the encoded video frames are decoded during playback. In some examples, the symbols or visual elements may comprise text, wherein the visual properties relate to any suitable text properties such as, for example, character content, language, font type, font size, color, thickness, motion, location, and orientation. Based on the determined legibility, one or more actions may be performed. In some embodiments, for example wherein the video coding parameters are modifiable, the determined legibility may cause or trigger a modification of the video coding parameters. The modified coding parameters may then be used in combination with the one or more visual properties of the video frames to determine a likelihood of causing legibility issues when the encoded video frames are decoded during playback. In some embodiments, if it is determined that legibility issues will be caused by the combination of the video coding parameters and the one or more visual properties of the video frames comprising symbols, metadata may be encoded (for example prior to, during, or following the encoding process), the metadata characterizing the symbols, optionally together with rendering information. The metadata may be associated with the video frames, or the encoded video frames, for use by compatible video players during playback, the video players caused to render the symbols as an overlay over the original symbols of the video frames, preserving clarity and legibility independently of any potential video quality degradation as a part of the encoding process.

According to systems and methods described herein, video frame data is received, the video frame data characterizing one or more video frames of a video comprising or depicting symbols. The term “video frame data” will be understood within the context of the present disclosure to mean any type of data associated with the video frames. The video frame data may, for example comprise raw, unprocessed video frames or any data associated therewith or characteristic thereof. The video frame data may, in some examples, comprise data associated with, or characteristics of, the video frames in any suitable form or at any stage of processing or transformation. This may in some examples include, but is not limited to, pixel-level information of the video frames, sub-frame or region-of-interest (ROI) level information of the video frames, metadata describing frame properties, processed representations such as encoded or compressed formats, or any suitable extracted features or characteristics derived from the frames (e.g., motion vectors or color histograms), or higher-level abstractions generated through analysis or manipulation of the video frames. In some examples, the term “video frame data” may refer to any such information as part of any suitable one or more data structures, such as arrays, objects, or hierarchical storage formats, whether individual or grouped to characterize one or multiple frames collectively.

The terms “visual elements” or “symbols” will be understood within the context of the present disclosure to mean any discernible character, mark, or graphical representation that is legible and serves to encode or convey language, semantic meaning, or instructional intent. This includes, but is not limited to, textual characters (e.g., letters, numbers, punctuation marks, and spaces), numerical digits, and graphical or non-alphanumeric elements such as arrows, emoticons or emojis, mathematical operators, special characters, and bar codes, QR codes or fiducials. Symbols are distinguished by their capacity to be recognized and interpreted within a given context, enabling them to function as components of linguistic, computational, or representational systems. Their legibility ensures they can carry significance, whether individually or as part of a structured sequence, and facilitates their role in communication, instruction, or representation.

It will be appreciated that any suitable receiving device may be used or configured for receiving the video frame data. In some examples, the video frame data may be received directly from a video frame capture device, or by way of any suitable intermediary storage device. In some examples, the video frame data may be received following any suitable processing, formatting, structuring, editing, conversion, translation or interpreting process. The video frame data may be any suitable combination of video frame data characterizing the one or more video frames comprising symbols. In some cases, a user device may be used to capture the video frame data. The captured data may be received for storage, for example at a memory of the user device. The video frame data may be processed using any suitable data processing tool prior to or following receipt.

In some examples, one or more encoding parameters is received, for encoding the one or more video frames. The term “encoding parameters” will be understood within the context of the present disclosure to mean any suitable one or more parameters associated with a video encoding process, defining or influencing how the video frames are, or will be, compressed, represented, or transmitted. This may include, but is not limited to, parameters such as quantization levels, bitrate(s), resolution, frame rate, compression level, encoding profiles, keyframe intervals, and color depth. It will be appreciated that the received encoding parameters may be in any suitable form, whether defined individually, collectively, or as part of a configuration. This may include parameters represented in any suitable data structure, such as arrays, objects, tables, or hierarchical formats, whether stored or transmitted independently or as part of an encoding system. These parameters may directly specify output characteristics or indirectly affect the quality, efficiency, or fidelity of the encoded video frames.

It will be appreciated that any suitable receiving device may be used configured for receiving the encoding parameters. In some examples, the encoding parameters may be received directly from an encoder device or module, or by way of any suitable intermediary storage device. In some examples, the encoding parameters may be received following any suitable processing, formatting, structuring, editing, conversion, translation or interpreting process. The encoding parameters may be any suitable combination of encoding parameters characterizing at least a portion of an encoding process to be used for encoding the one or more video frames comprising symbols. In some cases, a user device may comprise an encoding function, such as an encoding module, which may be used to generate the encoding parameters. The generated parameters may be received for storage, for example at a memory of the user device. The encoding parameters may be processed using any suitable data processing tool prior to or following receipt. Any suitable software or process may in some examples use, for example, feature engineering to generate or compute additional derived encoding parameters which may accompany, or be used in place of the encoding parameters.

In some examples, a legibility, such as represented by a legibility score for example, for the symbol or visual element of the one or more video frames is determined, based on the received video frame data and the one or more encoding parameters. The legibility, for example the legibility score, indicates a legibility of the symbol or visual element when the one or more video frames are encoded using the one or more encoding parameters and then decoded, for example for rendering. The term “legibility” will be understood within the context of the present disclosure to mean the quality of being clear enough to convey information or meaning, for example to be read or understood. The legibility may in some examples refer to human legibility, to computer legibility or any combination thereof. In the context of computer legibility, for example by way of optical character recognition (OCR) for text, the meaning of the term “legibility” may be understood to extend to the distinctiveness and consistency of characters or symbols within the video frames, and may include one or more visual attributes such as resolution, absence of distortions or artefacts, and the separation or distinction of symbols from the background or neighboring symbols.

The term “legibility score” will be understood within the context of the present invention to mean any suitable metric or determinant of legibility of the symbols in the decoded video frames, and may for example comprise, or be, a binary output or classification such as “legible” and “not legible”, or may be any suitable classification or continuous variable such as a percentage likelihood of legibility. In some examples, use of the term “legibility score” herein is not intended to be limited to a continuous variable or numerical value, and may be any suitable legibility classification as described herein. The legibility, for example the legibility score, is determined based on the received video frame data and the one or more encoding parameters, which may be used separately or in any suitable combination, such as in a composite data structure, for the determination. For example, the received video frame data and the one or more encoding parameters may be processed, for example normalized, either individually or in combination, for example as part of a composite data structure, which may act to ensure consistent input data quality to the legibility determination, for example as input data to a legibility model.

The determination may be performed by any suitable means, and may for example comprise a determining, estimating or predicting of the legibility using a computational legibility model. The legibility model may be any suitable model, and may in some examples comprise a machine learning model, such as comprising one or more neural networks, decision trees, or random forests. It will be appreciated that the machine learning model may be trained in any suitable manner, for example using a training dataset comprising images or video frames comprising one or more symbols, the images or video frames associated with one or more encoding parameters using which the images or video frames were encoded, and one or more predetermined legibility scores indicating a legibility of the symbols, or of each of the symbols, when the images or video frames are encoded using the one or more encoding parameters and then decoded. The predetermined legibility score may be provided in any suitable manner, such as by a human observer or by any suitable computational manner. In some examples wherein the predetermined legibility score is determined and attributed to the training images or video frames by a computational process, any suitable image processing or computer vision method may be used, such as optical character recognition (OCR). In some examples determining and attributing of the predetermined legibility score to the training images or video frames may comprise determining one or more display types or parameters, for example a display or screen size, a brightness, a contrast, a viewing distance, or any suitable metric or parameters such as described herein.

It will be appreciated that the legibility, such as a legibility score, may be determined for a corresponding symbol instance, which may comprise one symbol, or a group of symbols. In some examples therefore, one or more symbols or symbol instances of the video frames may be determined. In some examples, more than one symbol may be grouped into a single symbol instance based on a common symbol type (for example “text”, “arrows”, “fiducials”), and a corresponding legibility score may be determined for each group of symbol types. In some examples, the symbols may be grouped by any suitable parameter or metric, for example a determined importance or saliency of the symbol or symbols, a location of the symbol or symbols in the corresponding video frame, or an associated motion vector of the symbol or symbols. In some examples, one or more said groups of symbols may be weighted or prioritized based on any suitable type, parameters or metric such as a determined importance or saliency, which may in some examples depend on a particular application or use-case. In some such examples, the modifying of the video frame data or the encoding parameters may be based on a weight or prioritization applied to the legibility score based on a type, parameter or metric associated with the corresponding symbol or group of symbols. For example, if an application requires that text symbols, such as any suitable text characters, remain legible following encoding and decoding, it may be determined that the video frame comprises symbols of type “text”, the modification of the video frame data or the encoding parameters may be based on legibility scores associated with the symbols of type “text”. It will be appreciated that in some examples wherein the legibility score comprises a continuous metric, for example a percentage confidence of legibility, the legibility score may be compared to a legibility threshold. One or more legibility thresholds may be used, said legibility thresholds associated with one or more symbol types, metrics, parameters or weights, such as a saliency or importance associated with a symbol instance, group or type.

In some examples at least one of the received video frame data or the encoding parameters is modified based on the determined legibility score. The modifying of the received video frame data and/or the encoding parameters may in some examples be performed only in the event that the determined legibility score indicates that the symbols, when the video frames are encoded using the one or more encoding parameters and then decoded, are illegible. Such a determination may result from a classification output of a classifier, for example a trained classifier as described herein, or a determination that a predicted legibility or likelihood of legibility is below a legibility threshold. The modification of the received video frame data and/or the encoding parameters may be performed in any suitable manner, such as described herein.

In some examples, the legibility score may cause the modification of the received encoding parameters, or the selection of a different or alternative set of encoding parameters. It will be appreciated that any reference herein to a modification of the encoding parameters may refer to an altering the encoding parameters or to a selection of alternatives to the encoding parameters.

In some examples, modifying the received video frame data or the encoding parameters may comprise: determining, based on the legibility score, one or more sets of modified or alternative encoding parameters. The one or more sets of modified or alternative encoding parameters may be any suitable combination of modifications made to, or alternatives to, the received encoding parameters, which may in some examples aim to increase the legibility of the symbols in the decoded video frames or increase the level of compression of the video frames. In some examples, wherein the legibility score indicates that the symbols of the decoded video frames are legible, or is greater than a predetermined legibility threshold, the one or more sets of modified or alternative encoding parameters may be determined so as to increase a compression level of the video frames when encoded using the modified encoding parameters. The legibility determination may in such examples be used to increase a level of compression in scenarios wherein legibility of the symbols is maintained at higher compression levels than that set by the received encoding parameters. In some examples, wherein the legibility score indicates that the symbols of the decoded video frames are not legible, or is below a predetermined legibility threshold, the one or more sets of modified or alternative encoding parameters may be determined so as to decrease a compression level of the video frames when encoded using the modified encoding parameters. The legibility determination may in such examples be used to increase legibility while maintaining a level of compression. The modified or alternative encoding parameters may in some examples be used to perform a further legibility determination in combination with the video frame data. For example, based on the received video frame data and the one or more sets of modified encoding parameters, one or more further legibility scores for the symbols in the one or more video frames may be determined. In some examples, based on the further legibility score for the one or more modified or alternative sets of encoding parameters, one or more of the sets of modified encoding parameters may be selected, for example for encoding the one or more video frames. In some examples, a plurality of sets of modified or alternative encoding parameters may be determined for use in determining the further legibility score, wherein a selection of an optimal set of modified or alternative encoding parameters may be made based on the legibility score as described herein. It will be appreciated that while some examples may modify the received encoding parameters to balance legibility and compression level, any suitable aspect of the encoding process may be balanced against legibility in order to maintain legibility of the symbols of the decoded video frames. In some examples, a plurality of sets of encoding parameters, for example corresponding to respective bitrate versions of the encoded video frames, may be determined. Any suitable encoding parameters will be appreciated, and may, for example, comprise one or more selected from the group: bitrate; resolution; compression level; quantization; encoder type; codec. It will be appreciated that any suitable feature engineering may be used in some examples to determine one or more suitable encoding parameters outside of this group.

In some examples modifying the received video frame data or the encoding parameters may comprise: determining or accessing, based at least in part on the encoding parameters, a quality-bitrate curve for a plurality of bitrate versions of the one or more video frames. The quality bitrate curve may, in some examples, be intended for use in generating multiple bitrate versions of the received video frames using the received encoding parameters. The determining or accessing of the quality-bitrate curve may be performed in any suitable manner, and may for example be accessed or determined based on a known, predetermined or modeled pattern or correlation between video frame data and encoding parameters. For example, in some cases the quality-bitrate curve may be accessed from a stored or generated look-up table, or may be determined algorithmically, based on the known, predetermined or modeled pattern or correlation between video frame data and encoding parameters. In some examples, the determined quality-bitrate curve may be modified, based on the legibility score. It will be appreciated that the modification of the quality-bitrate curve may be performed to increase compression while maintaining legibility of the symbols of the decoded video frames. In some examples, a bitrate ladder configuration may be generated, based on the modified quality bitrate curve, for encoding the one or more video frames. The bitrate ladder may, for example, be used to encode more than one bitrate version of the one or more video frames, such as for use in adaptive bitrate (ABR) streaming techniques. The modification of the quality-bitrate curve may therefore enable the provision of adaptive bitrate streaming approaches while maintaining legibility of symbols of the decoded video frames across all, or an increased number of, bitrate versions of the encoded video frames.

In some examples, modifying the received video frame data or the encoding parameters may comprise: determining or selecting one or more of the received encoding parameters to be modified. In some examples, a modification of the video frame data or the encoding parameters may be determined based on the video frame data, the encoding parameters, and the determined legibility or legibility score. In some examples, the one or more encoding parameters to be modified may be determined from a predetermined list of encoding parameters or encoding parameter types. The determining of the one or more encoding parameters to be modified may, in some examples, comprise determining one or more encoding parameters or encoding parameters types, or one or more modifications thereto, which are estimated or predicted to cause a positive legibility of the symbols of the video frames following encoding and decoding for playback.

In some examples, modifying the received video frame data or the encoding parameters may comprise: receiving, retrieving, identifying, measuring, determining or generating, based on the video frame data, metadata associated with the symbol or visual element in the one or more video frames, the metadata configured to cause rendering of a recreation of the symbols overlaid over the symbol or visual element in the video frames when the encoded video frames are decoded. In some examples therefore, the legibility score may be used to generate metadata associated with the video frames, and optionally associated with the symbols of the video frames, the metadata configured to be used to render a recreation of the symbols overlaid over the original symbols of the encoded video frames during playback. In some such examples, the rendered recreation of the symbols may comprise one or more known or constant visual characteristics (which may be any suitable visual characteristic such as described herein), or encoding parameters, the known or constant visual characteristics or encoding parameters associated with a positive legibility. For example the legibility of the rendered recreation of the symbols may, such as based on the one or more known or constant visual characteristics or encoding parameters, be configured to remain the same irrespective of the encoding parameters used to encode the video frames. Therefore, in some such examples, encoding parameters associated with high levels of compression of the video frames, which may typically cause the symbols to become illegible in the decoded video frames, may not affect the legibility of the recreation of the symbols rendered as an overlay in the decoded video frames. In some examples, the one or more known or constant visual characteristics may be associated with one or more visual characteristics of the symbols of the video frames, and may therefore in some such examples cause a rendered recreation of the symbols which closely resembles the original, or intended, symbols of the received video frames. In some such examples therefore, the method may comprise determining the one or more visual characteristics, such as symbol-specific visual characteristics as described herein, of the symbols of the received video frames. In some examples, one or more determined visual characteristics of the received video frames may be associated with a low or negative legibility score, and in some such examples therefore, the one or more known or constant visual characteristics may comprise a higher legibility than that of the one or more determined visual characteristics.

In some examples, modifying the received video frame data or the encoding parameters may comprise: adjusting one or more visual characteristics of the received video frames. In some examples, one or more of the received video frames may be determined to comprise one or more visual characteristics associated with a low or negative legibility score, and the one or more visual characteristics may be adjusted based on one or more visual characteristics associated with a higher legibility score. In some such examples therefore, the received video frames may be directly modified prior to encoding such that visual characteristics therein are more likely to provide a higher legibility of symbols in the decoded frames for playback. In some such examples, the one or more adjusted visual characteristics may comprise symbol-specific visual characteristics as described herein. For example, any suitable image processing or image enhancement process may be used to modify or enhance one or more visual characteristics of the video frames prior to performing a further legibility determination.

It will be appreciated that any such combination of modification of the encoding parameters and modification of the video frame data may be performed. It will be appreciated that, in some examples, the modified video frame data or the modification encoding parameters may be further modified based on the further legibility determination. For example, in the event that the further legibility determination indicates that the symbols of the video frames remain illegible following encoding and decoding using the modified video frame data or encoding parameters, the modified video frame data or modified encoding parameters may be further modified. In some examples, the further legibility determination may be repeated using, or based on, the further modified video frame data or encoding parameters. Such an iterative or cyclic modification may be performed in any suitable manner as described herein, and for any suitable number of times, for example until a positive legibility is determined.

In some examples, the one or more video frames may be encoded based on the modified video frame data or the modified encoding parameters. In some examples, the encoding may be performed based on the determined legibility or the legibility score of the further legibility determination. For example, the encoding may in some examples be performed based on a positive legibility or legibility score of the further legibility determination. In some examples wherein the legibility or legibility score is a continuous metric, the encoding may be performed based on a legibility or legibility score of the further legibility determination above a predetermined legibility threshold. It will be appreciated that the described methods and systems may be incorporated at any stage within an encoding pipeline, or wherein the described methods and systems may be used to inform aspects of video frame capture and storage, for example determining one or more video frame capture parameters of an image capture device.

In some examples, one or more regions of interest may be determined within the one or more video frames, based on the video frame data, the one or more regions of interest comprising the symbol or visual element. Any suitable determination of the regions of interest will be appreciated, and may for example comprise any image or pattern recognition tool or application, such as optical character recognition (OCR). In some examples, a saliency analysis may be performed on the one or more regions of interest. In some examples, one or more salient regions of interest may be determined based on a saliency analysis of the one or more regions of interest. Determining the legibility score may in some examples be based at least in part on the one or more salient regions of interest. The term “saliency evaluation” will be understood to mean any suitable method of identifying within, or isolating from, the video frame data one or more objects, regions or features of interest. The saliency evaluation may, in some examples, be performed using any suitable deep learning approaches such as, for example, convolutional neural networks and generative adversarial networks, and any deep learning model used may learn saliency cues from a training dataset for use in the saliency evaluation.

Performance of the saliency evaluation may require a saliency evaluation of objects, regions or features already determined to be present in the video frame data, such as objects, regions or features associated with symbols. Such a determination may be performed by any suitable tool or process, for example using OCR. Such a determination may therefore represent a first data reduction step prior to a saliency evaluation, thereby reducing the computational resources required for the downstream saliency evaluation. The one or more objects, regions or features of interest may comprise the symbols. It will be understood that the saliency evaluation may be any suitable saliency evaluation technique, and may comprise any combination of bottom-up or top-down saliency evaluation techniques. By way of example, in a bottom-up saliency evaluation technique the one or more objects, regions or features of interest may be identified based on any suitable symbol-specific visual characteristics of the symbols of the video frames, such as font; font size, thickness, color; location; orientation; motion. By way of further example, in a top-down saliency evaluation technique the one or more objects, regions or features of interest may be identified based on any suitable factors, for example external factors, relating to the video frame data, which may in some examples include data or metadata associated with the video frame data.

The factors may include, or be associated with, a semantic context associated with the video frame data, the semantic context being identified within the data or metadata associated with the video frame data. For example, features, regions or objects of interest may be identified that, in accordance with the semantic context, are determined to be meaningful or important to the context of the video frame, and thereby have a higher likelihood of being determined to be salient by the saliency evaluation. For example, the video frame data may be associated with live captured traffic images captured by an image capture device of a vehicle for the purpose of viewing in the event of a traffic incident. The video frame data may comprise traffic-related symbols, visual elements, or text, such as that of traffic signage or vehicle license plates. In some examples, the video frame data may be processed using any suitable image processing method, and traffic-related symbols, visual elements, or text identified within the video frame data may be determined to relate to such a sematic context. For example, within the video frame data traffic-related symbols, visual elements, or text, such as that of traffic signage or vehicle license plates, may be identified and used in the saliency analysis. The semantic context may influence the identification of the one or more features, regions or objects of interest as part of the saliency evaluation. The determination may be supported by a feature recognition or object recognition process as part of the saliency evaluation. The features, regions or objects of interest (such as the symbols, visual elements, or text) may be segmented from the received video frame data based on the identification, using any suitable segmentation process. More accurate saliency evaluation may help to reduce the amount of unnecessary data included in downstream processing for performing the legibility determination and any associated generation of modified video frame data or encoding parameters, or associated metadata.

In some examples, one or more symbol-specific visual characteristics may be determined based on the video frame data, wherein determining the legibility score may be based at least in part on the one or more symbol-specific visual characteristics. The symbol-specific visual characteristics may be any suitable visual characteristics associated with the symbols, and may for example be any suitable characteristics associated with any text which may be comprised among the symbols, such as a font type or style, or a font size (for example a size of a bounding box area positioned about the symbols, such as during a segmentation process as described). Other suitable characteristics may comprise a thickness of any symbols, such as a stroke width, a sharpness or aliasing value or metric, such as an edge sharpness metric for example an average gradient magnitude along edges of the symbols, or a detected or determined language or script type (for example Latin, Cyrillic or any other suitable language or script type which may be identified). The one or more visual characteristics may in some examples comprise data characteristic of a contrast, such as a symbol-to-background contrast value or metric. In examples wherein the symbols are detected across multiple of the received video frames, the one or more visual characteristics may comprise motion data, such as a motion vector or motion vector magnitude associated with the symbols. The one or more visual characteristics may comprise data characterizing a location or position of the symbols such as coordinates (for example an x-y value), size (for example a width and a height), and orientation (for example a rotation angle). The one or more visual characteristics may comprise a color profile of the symbols, for example any suitable color profile such as RGB values of the text color and/or background color, or any suitable combination thereof. It will be appreciated that the symbol-specific visual characteristics may comprise any suitable combination of symbol-specific visual characteristics described herein, which may be combined or collated in any suitable data structure for use in determining the legibility.

In some examples, one or more display parameters or display specifications may be determined. The display parameters or the display specifications may be any suitable parameters or specifications associated with a display configured to display the decoded video frames during playback. For example, a display screen size, resolution, pixel density, color gamut, brightness or contrast, among others as will be appreciated, may be determined. Such parameters or specifications may, in some examples, be combined or collated in any suitable data structure for use in determining the legibility.

In some examples, one or more viewing conditions may be determined. The viewing conditions may be any suitable conditions associated with the viewing environment of a display configured to display the decoded video frames during playback. For example, a viewing distance, a viewing angle, one or more lighting condition metrics, or a glare metric, among others as will be appreciated, may be determined. Such conditions may, in some examples, be combined or collated in any suitable data structure for use in determining the legibility.

In some examples, the one or more display parameters or display specifications, and the one or more viewing conditions, may be combined with the video frame data and the encoding parameters in any suitable combination thereof for use in determining the legibility.

In some examples, the symbol or visual element may comprise text, such as any suitable characters associated with text, such as language, letters, digits, special characters, punctuation or spaces. Examples will be appreciated wherein the symbols are any suitable symbols as described herein.

In some examples, determining the legibility score may comprise: processing, using a predictive model, the video frame data and the one or more encoding parameters; and outputting, using the predictive model, the legibility score. For example, the video frame data (which may in some examples comprise the visual characteristics, such as the symbol-specific visual characteristics) and the encoding parameters may be provided to the predictive model as input data, and wherein the legibility score is output from the predictive model. Any suitable predictive model will be appreciated, and may for example comprise any suitable neural network or deep learning architecture, random forest or decision tree.

In some examples, the predictive model is a machine learning model, for example comprising a legibility classifier or regressor, trained using a labelled training dataset, the training dataset comprising a plurality of video frames comprising symbols, a corresponding set of encoding parameters for each of the plurality of video frames, and a predetermined legibility score for each of the plurality video frames.

It will be appreciated that any features of the present disclosure may be performed on any combination of devices or device components, including transmission between devices and remote servers. In accordance with some examples of the present disclosure, the one or more video frames may be captured, for example by an image capture device, prior to receipt. The image capture device may be any suitable device, for example a mobile device camera. In some examples, at least one of the one or more video frames and the one or more encoding parameters may be received by way of a remote device, for example a remote server, such as at a user device.

In accordance with some examples of the present disclosure, there is provided a method of training a legibility prediction model. In some examples the method may comprise labelling, using a legibility score, one or more images and/or video frames comprising symbols, the legibility score indicating a legibility of the symbols of the images and/or video frames when encoded using one or more encoding parameters, and decoded for viewing or playback. The labelled images and/or video frames, and the corresponding encoding parameters may form a training dataset for a legibility prediction model. The legibility prediction model may then be trained using the training dataset comprising the labelled images and/or video frames, and the corresponding encoding parameters, such that the legibility model is configured to output a legibility score based on the training dataset. In some examples, the labelled images or video frames comprise labelled image data or video frame data characterizing the images or video frames, in any suitable manner as described herein.

In some examples, the modified video frame data and/or the modified encoding parameters may be stored in any suitable memory, for example a local memory of a user device, or at a memory of a remote server. The modified encoding parameters may be stored alongside or in association with the (optionally modified) video frame data. Storing the (optionally modified) video frame data may comprise modifying the video frame data, for example meta data associated therewith, such as to include an association with the modified encoding parameters. The storing of the (optionally modified) video frame data and the modified encoding parameters may in some examples comprise storing any combination of the (optionally modified) video frame data and the modified encoding parameters. In some examples, the (optionally modified) video frame data may be encoded by any suitable encoding method, for example using the modified encoding parameters, prior to storage.

It will be appreciated that any process steps and functionality of the present disclosure, in any suitable combination thereof, may be performed on a user device or at a server. The performance of steps or functionality at a server may in some cases act to conserve memory and computational processing resources on a user device.

It will be appreciated that any features described herein as being suitable for incorporation into one or more examples of the present disclosure are intended to be generalizable across any and all examples of the present disclosure.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1A illustrates an overview of an example system for providing symbol or visual element legibility prediction for use in encoding one or more video frames, in accordance with some examples of the disclosure;

FIG. 1B depicts a more detailed view of the system, and example use thereof, of FIG. 1A;

FIG. 2 depicts a flowchart representing steps of an example process for providing a visual element or symbol legibility prediction for use in encoding one or more video frames, such as using the example system of FIG. 1A and FIG. 1B, in accordance with some examples of the disclosure;

FIG. 3A depicts an example received video frame depicting a road sign, suitable for use in accordance with the disclosure;

FIG. 3B depicts the example video frame of FIG. 3A encoded using an example set of one or more encoding parameters and then decoded for playback, wherein a legibility of the decoded video frame may be predicted based on a legibility score determined in example embodiments of the disclosure;

FIG. 4 depicts an example modified version of the video frame of FIG. 3A encoded using the example set of one or more encoding parameters of FIG. 3B and then decoded for playback, the modified version including metadata associated therewith for rendering symbols of the received video frame of FIG. 3A during playback, in accordance with the present disclosure;

FIG. 5 shows a sequence diagram indicating steps of an example video encoding process which may be used in accordance with the disclosure;

FIG. 6 shows a sequence diagram indicating steps of an example process for preparing a composite feature vector comprising received video frame data and received encoding parameters in accordance with the disclosure;

FIG. 7 shows a sequence diagram indicating steps of an example process for modifying video frames or one or more encoding parameters based on a legibility score, in accordance with the disclosure;

FIG. 8 depicts a flowchart representing steps of a further example process with steps suitable for incorporation into the example process of FIG. 2, for providing a visual element or symbol legibility prediction for use in encoding one or more video frames, in accordance with some examples of the disclosure;

FIG. 9 shows a sequence diagram indicating steps of an example process for performing a legibility score determination in accordance with the present disclosure based on multiple encoded parameter sets;

FIG. 10 depicts a flowchart representing steps of a further example process with steps suitable for incorporation into the example process of FIG. 2, for providing a visual element or symbol legibility prediction for use in encoding one or more video frames, in accordance with some examples of the disclosure;

FIG. 11 shows a sequence diagram indicating steps of an example process for modifying video frames with embedded metadata for encoding, in accordance with the disclosure;

FIG. 12 shows a sequence diagram indicating steps of an example process for playback of the modified video frames of FIG. 11 comprising embedded metadata, in accordance with the disclosure;

FIG. 13 depicts a flowchart representing steps of an alternate example process to that of FIG. 2, for providing a visual element or symbol legibility prediction for use in encoding one or more video frames, in accordance with some examples of the disclosure;

FIG. 14 depicts a flowchart representing steps of a further alternate example process to that of FIG. 2, for providing a visual element or symbol legibility prediction for use in encoding one or more video frames, in accordance with some examples of the disclosure;

FIG. 15 depicts a flowchart representing steps of a further alternate example process to that of FIG. 2, for providing a visual element or symbol legibility prediction for use in encoding one or more video frames, in accordance with some examples of the disclosure; and

FIG. 16 is a block diagram showing components of an example system for providing a visual element or symbol legibility prediction for use in encoding one or more video frames, in accordance with some examples of the disclosure.

### DETAILED DESCRIPTION

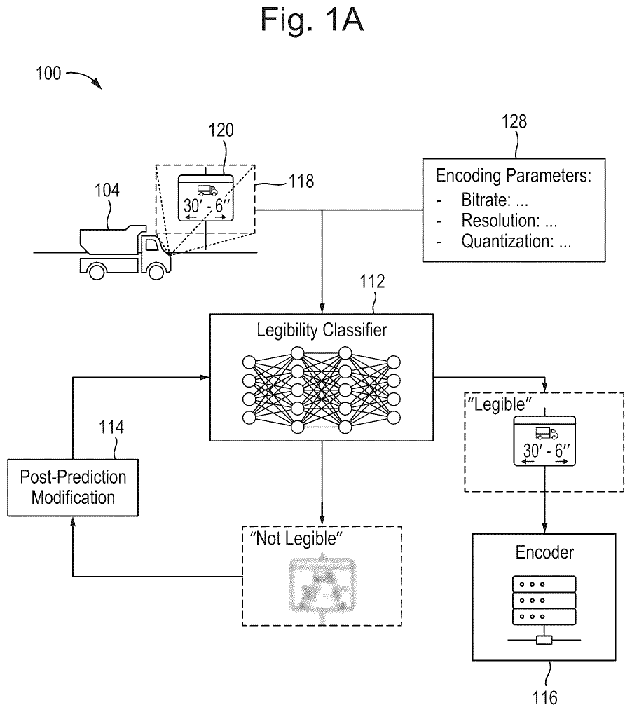

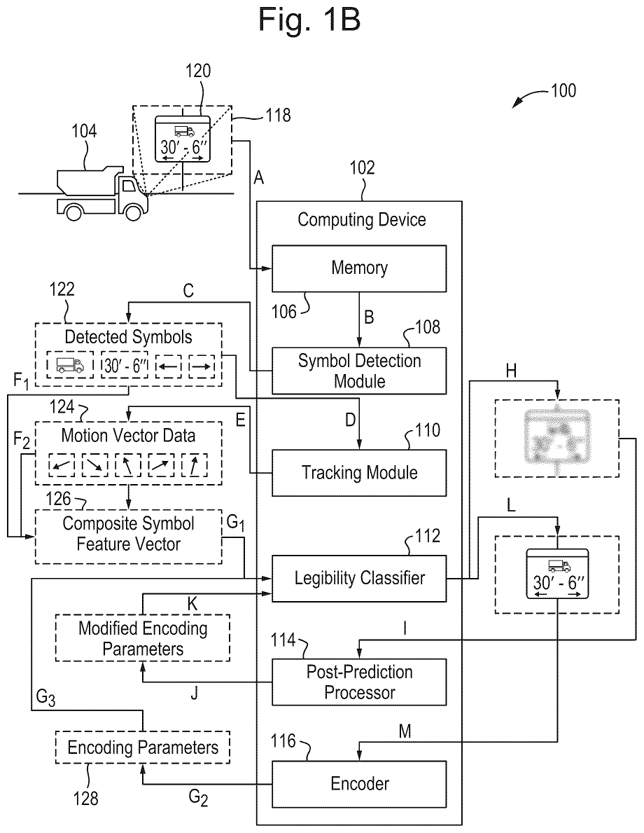

FIG. 1A illustrates an overview of an example system 100 for providing a text or symbol legibility prediction for use in encoding one or more video frames, in accordance with some examples of the disclosure. One or more video frames 118 may be captured by an image capture device, for example of a user device, which in the example 100 shown is a vehicle 104 driving along a road. The one or more video frames 118 depict a road sign 120 comprising text and symbols, and are captured by the image capture device of the vehicle 104 as the vehicle 104 travels along its journey. The one or more video frames 118 may be stored at a memory, local or remote to the vehicle 104, and used to review the journey of the vehicle 104, for example in the event of a traffic incident occurring during the journey. Prior to storage, or communication for storage, of the one or more video frames 118, a first set of encoding parameters 128 are determined, for example at a server following a request to encode the captured one or more video frames 118 for storage or transmission. The one or more video frames 118 (or any suitable video frame data characteristic thereof), and the first set of encoding parameters 128 are provided as input to a legibility classifier 112. The legibility classifier 112 is configured to predict, based on the video frames 118, or the associated video frame data, and the encoding parameters 128, whether symbols, visual elements, or text within the video frames 118 will remain legible (e.g., by returning the classification, “Legible”) or not (e.g., by returning the classification, “Not Legible”) following encoding using the encoding parameters 128 and decoded for playback. In the event that the symbols of the video frames 118 are predicted to be not legible following encoding and decoding, a post-prediction modification module 114 may perform a modification of the first set of encoding parameters 128 or of the video frames 118 or associated data, for performing a further legibility classification. On predicting that the symbols of the video frames 118 are expected to be legible following encoding and decoding, the video frames 118 may be encoded by an encoder 116 using the (optionally modified) encoding parameters.

FIG. 1B illustrates a more detailed overview of the example system 100 of FIG. 1A. In particular, FIG. 1B depicts stages (labelled A-L) in a process of providing the text or symbol legibility prediction. As shown more clearly in FIG. 1B, the system 100 comprises a computing device 102 which may be comprised within a client device, for example a user device or a vehicle 104 such as that shown in FIG. 1A and FIG. 1B. The computing device 102 comprises a memory 106, a symbol detection module 108, a tracking module 110, a legibility classifier 112, a post-prediction processor 114, and an encoder 116.

As described for FIG. 1A, the vehicle 104 may comprise an image capture device (not shown) configured to capture image data characterizing the environment about the vehicle 104. For example, as the vehicle 104 moves along a road, the image capture device may be configured to capture image data, including one or more video frames 118, of objects in the environment, such as road traffic signs 120. At A, the video frames 118 characterizing the road traffic signs 120 may be stored locally at the memory 106 of the computing device 102.

At B, the stored video frames 118 may be communicated to, or accessed by, the symbol detection module 108 for the purpose of, at C, detecting one or more symbols in the one or more video frames 118. At or prior to accessing of the video frames 118 by the symbol detection module 108, the video frames may be pre-processed, for example divided into single video frames or groups of frames, such as groups of pictures (GOP). The dividing of the video frames 118 may be performed in any suitable manner and may for example comprise one or more steps of an encoding process, and in such examples may depend on a particular encoding standard used. GOP structures may be implemented in some examples to improve compression efficiency, and may allow for temporal compression by storing only differences between frames rather than redundant pixel data. Such dividing or segmentation of the video frames may help the system 100 process the video frames in sections, which may be useful for high-resolution or high-bitrate video frame capture, where analyzing each frame individually may be computationally intensive. By grouping the video frames, the system may process temporal data more efficiently, allowing symbol detection and tracking to operate effectively on relevant segments of the video frames without unnecessary computational overhead.

The symbol detection module 108 is configured to identify areas within each of the video frames comprising symbols. The symbol detection module 108 may implement any suitable symbol detection process, for example optical character recognition (OCR) for detecting text within the video frames, or any suitable deep-learning-based models which may be trained for text or symbol detection in images and video. The symbol detection module 108 may be configured to recognize any suitable symbol-specific characteristic as described herein, such as font types, font sizes, symbol types, and symbol orientations among others. The symbol detection module 108 may, for example, scan each of the video frames 118 (or each frame of a pre-processed GOP), and may identify regions of interest within the frames 118 which comprise symbols. In some examples, the symbol detection module 108 may detect the symbols based on a probability or likelihood determination, which may for example indicate the likelihood of a region of interest comprising symbols. The symbol detection module 108 may distinguish between symbols and similar-looking objects or patterns which may be located in the background of a video frame. Deep learning techniques may be employed to adapt to different video frame content styles, applications or use cases, ensuring accurate symbol detection across a range of such use cases and content or video types, such as news broadcasts, movies, and advertisements.

In the text legibility prediction system 100, symbol-specific visual characteristics such as font and size recognition may be important in understanding the visual characteristics of the detected regions of interest comprising (or having a high likelihood of comprising) symbols. The system may, for example, use OCR libraries with advanced capabilities for font-type classification, allowing it to distinguish between various font types or styles (e.g., serif, sans-serif, bold, italic) which may be commonly used in video content. Recognizing the font type or style may aid in predicting how well the symbols, visual elements or text may render during decoding and playback after encoding with the received encoding parameters, since particular font types or styles may maintain legibility better under compression than others. Additionally, the size of the symbols, visual elements or text may be calculated, or otherwise determined, for example based on pixel dimensions within a detected bounding box, giving an indication of how legible the symbols, visual elements or text will be. One or more display properties (for example, screen size or screen resolution) of a playback device, such as a user device, may be determined or received, and the legibility determination may at least in part be based on the one or more display properties. A color of the symbols, visual elements, or text may be determined, for example relative to a background color or as a contrast metric, which may further aid in determining the legibility, and may aid in modifying, adjusting or verifying the contrast level against the background. In some examples, a language and/or script type may also be recognized as part of the legibility determination, based on, for example a recognition of characters such as Latin, Cyrillic and Chinese characters.

The visual characteristics may, in some examples, be used to determine a visibility, or a visibility score, the visibility or visibility score used in the legibility determination. In some such examples, the visual characteristics contributing to the visibility or the visibility score, may include contrast between symbols, visual elements or text and a background of the video frame, a thickness of the symbols, visual elements or text, and a color contrast. Low-contrast symbols, visual elements or text may be associated with a blending with the background of the video frame, reducing visibility, which may particularly affect legibility of the symbols, visual elements or text after a lossy compression, making the symbols, visual elements or text difficult to read. In some such examples, for each symbol or text instance identified within the video frames, the system may determine one or more of such characteristics, such as for example, a level of contrast, a color profile, and a text thickness, which may together define a visibility score for the text or symbol instance.

In the example shown, the symbol detection process performed by the symbol detection module 108 identified a plurality of symbols or visual elements 122 in the video frames 118, which are associated with the information conveyed within the road traffic sign 120 within the video frames 118. The road traffic sign 120 shown indicates a vehicle length restriction, and the symbols 122 detected by the symbol detection module 108 comprise an indication of a truck, text information detailing the length restriction, and arrows indicating that the restriction applies to the length of the vehicle.

The detected symbols or visual elements 122, or regions of interest within the video frames occupied thereby, may be further processed to determine one or more visual characteristics thereof as described.

The symbol detection module 108 may communicate the detected one or more symbol or text instances to the tracking module 110. For each of the one or more detected symbol or text instances 122 within the one or more video frames 118, the tracking module 110 may determine a motion vector 124 to understand how the symbol or text 122 moves across the corresponding video frames 118. The tracking module 110 may, for example, perform a motion vector analysis involving tracking the position of the symbol or text instance 122 over consecutive video frames 118, such as calculating the velocity and direction of movement of the symbol or text instance 122. Such tracking may aid against blur or distortion caused by moving symbols, visual elements or text across multiple sequential video frames, for example under temporal compression used in video encoding. By understanding motion of detected symbols, visual elements or text 122 across the video frames 118, the system 100 may predict potential legibility issues, as symbols, visual elements or text which moves too quickly across the video frames, or which exhibits complex motion patterns (such as rotation or scaling), may be predicted to become illegible after encoding with particular encoding parameters. The determined motion vectors may offer insights into how much residual or compensation might be needed in modification of the encoding parameters or the video frame data, such as to provide an overlay using metadata, to ensure consistent readability.

After detecting symbols, visual elements or text 122 in a video frame 118 by the symbol detection module 108, the tracking module 110, at D, may apply a tracking algorithm to monitor the movement and position of the detected symbols, visual elements or text 122 across subsequent video frames 118. The tracking may be performed in any suitable manner, such as using any suitable object tracking algorithms, or tracking by detection, and may in some examples be implemented using motion estimation by a codec within an encoding pipeline. By tracking the symbol or text movement, the tracking module can extract the described features related to motion of the text as motion vector data 124, at E. The tracking and associated motion vector data may in some examples aid in maintaining accurate metadata for each detected symbol or text instance 122, which may benefit a rendered overlay using associated metadata in cases of predicted poor legibility for a given set of encoding parameters.

It will be appreciated that in some examples, the determination of visual characteristics of the symbols, visual elements or text instance may be performed by a feature extraction process performed subsequent to the tracking by the tracking module 110, and based thereon. By way of example, for each of the video frame 118 where symbols, visual elements or text are detected, the symbol detection module 108 may determine bounding box coordinates, which define the spatial location of the symbol or text instance 122 within the video frame 118. Tracking of the symbol or text instance 122 across video frames by the tracking module 110 may then be used to provide temporal data, enabling the system to determine how the symbol or text instance 122 moves or changes over time. In some examples, the resultant motion vector data 124 output may be used as a foundation for subsequent processing steps, such as feature extraction, by providing precise information about symbol or text placement, motion, and appearance in the video frames.

In some examples, and as illustrated in FIG. 1A and FIG. 1B, the output of the symbol detection 108 and tracking 110 processes may be a composite feature vector 124, formed at F₁ and F₂, as a structured dataset 126 comprising at least the positional and visual characteristics of each detected symbol, visual element, or text instance 122. The composite feature vector 126 may comprise any suitable combination of the extracted video frame data, which may include one or more visual characteristics of the text or symbols of the video frames, such as language or script type, location, orientation, size, font type or style, font size, motion vector, text contrast, and color profile. Such data may be compiled into the structured feature set 126 which is used to comprehensively describe each detected symbol or text instance 122.

By way of example, the extracted features forming the composite feature vector 126 may provide a comprehensive mathematical representation of each of the symbol or text instances 122. Such an example feature vector, F, for a detected symbol or text instance 122 may be represented as:
F=[S, C, M, TT, ES, FS, L, P, C], where:

S: font size (e.g., determined by a bounding box area), C: text-to-background contrast, M: motion vector magnitude, TT: text thickness (e.g., stroke width), ES: edge sharpness (e.g., average gradient magnitude along edges), FS: font type or style (e.g., categorical variable indicating font type or style, such as serif, sans-serif, etc.), L: language or script type (e.g., categorical variable indicating script, such as Latin, Cyrillic, etc.), P: position (e.g., an x-y coordinate, width, height, rotation or orientation angle within the video frame, etc.), and C: color profile (e.g., any suitable color metric, such as RGB values of the symbol or text color and/or the background color).

Such an example feature vector, F, may encapsulate all necessary characteristics for evaluating symbol or text legibility by the legibility classifier. Such a combination of information and data may be useful in assessing text legibility, and may additionally assist in determining or generating metadata for use in providing a rendered overlay of symbols, visual elements or text in some examples, which may provide assurance that even in a scenario wherein video encoding using the encoding parameters degrades symbol or text legibility, key information from the symbols, visual elements or text can still be presented accurately during decoding and playback. The feature vector F, may for example serve as the composite feature vector 126 as an input to a the legibility classifier 112 for the legibility prediction. A structured representation of the detected symbol or text instances may enable the system to make precise predictions and convey information suitable for generating a rendered overlay of symbols, visual elements or text in some examples as described herein.

At G₁, the composite symbol feature vector 126 (such as, for example, feature vector F described above) is received as input by the legibility classifier 112. At G₂, a first set of encoding parameters 128 are determined by way of the encoder 116, for receipt, at G₃, by the legibility classifier 112 as part of the input. In some examples, the first set of encoding parameters may be determined by a parameter analysis module, for example of an encoder. The first set of encoding parameters may be any suitable parameters characterizing a video encoding process, or one or more parts or sections thereof. Different types of encoding parameters can be associated with the introduction of artefacts or distortions which may degrade symbol or text clarity and legibility in video frames. In some examples, the first set of encoding parameters may be selected from available encoding parameters, for example based on one or more video encoding settings associated with symbol or text legibility. By way of example, encoding parameters which may form part of the first set of encoding parameters may include an encoder type or identifier, and any suitable parameters used during video encoding such as bitrate, resolution, and compression level, each of which may affect a final video quality and, consequently, symbol or text legibility.

Encoder types may apply different encoding algorithms and handle video compression differently, and may therefore differentially affect the legibility of symbols, visual elements or text in the decoded video frames. For example, both encoders H.264 and H.265 may help optimize for storage efficiency but may each introduce distinct types of visual artefacts.

Bitrate may be one of the factors of video encoding associated with influencing decoded video quality and, by extension, symbol and text legibility. Bitrate may determine an amount of data used to encode a video stream per unit of time, with higher bitrates allowing for greater detail and less compression-related loss in video quality. Higher bitrates are generally associated with improving symbol or text legibility by preserving finer details within each video frame, including relatively small or thin fonts. When the bitrate is lower, however, more visual information is lost or discarded during the encoding process, and may often cause symbols, visual elements or text to appear blurry or pixelated, particularly when the symbols, visual elements or text is small, thin or stylized. By incorporating bitrate into the first set of encoding parameters, the legibility classifier may better estimate whether symbols, visual elements or text will remain legible at specific bitrates, or if modifications to the encoding parameters or the video frame data, such as incorporating supplemental metadata for rendering a symbol or text overlay during decoding and playback, may be necessary to preserve legibility.

Resolution may be a further factor of video encoding associated with influencing decoded video quality and, by extension, symbol and text legibility. Resolution may determine the spatial detail within each video frame, and lower resolutions may reduce the pixel density of the video frames, which can lead to the loss of sharp edges and detail for small symbol or text elements. When resolution of video frames is downscaled as part of an encoding process, the encoded video frames may lose key form and identifying aspects of symbol and text, such as fine lines in serif font styles, or small diacritical marks, thereby reducing legibility. Conversely, higher resolutions may retain more visual detail, making it easier to distinguish symbols, visual elements or text characters. By accounting for resolution as part of the first set of encoding parameters, the system may make informed predictions about legibility and determine if symbols, visual elements or text might require enhancement or overlay at lower resolutions, or whether a higher resolution is to be selected. In some examples, frame rate may also be considered as part of the first set of encoding parameters, as the motion of symbols, visual elements or text may be calculated based on an input frame rate of the video frames. If the frame rate is modified, for example as part of an encoding process, this may also affect a legibility prediction performed by the legibility classifier 112.

Compression level may be a further factor of video encoding associated with influencing decoded video quality and, by extension, symbol and text legibility. Compression algorithms may reduce file size by discarding visual details that may not be noticeable in general viewing, but which can adversely affect the legibility of symbols, visual elements or text. By way of example, an aggressive quantization (a common technique used in compression) can lead to a blocky quality around characters, making edges appear rough or blurred.

Combining the first set of encoding parameters, which may comprise one or more of the encoding parameters described herein, in some examples a composite encoding parameter feature vector, E, may be determined, for presentation as input to the legibility classifier. By way of example, a composite encoding parameter feature vector, E, may be defined as follows:
E=[E_type, Bitrate, R, FR, QP], wherein:

E_type: encoder type (e.g., a categorical feature such as an encoder identifier), Bitrate: bitrate (e.g., a continuous feature), R: resolution (e.g., width by height), FR: frame rate (e.g., frames per second), and QP: compression level (e.g., a quantization level).

Such a composite encoding parameter feature vector E, when combined with the composite symbol feature vector, F, may provide a comprehensive representation of encoding conditions that are likely to influence symbol or text legibility. Such a combination may aim to provide a robust dataset that captures both the inherent qualities of the symbol or text instance (e.g., font style, size, and contrast among others as described herein) and the effects of the first set of encoding parameters (e.g., bitrate, resolution, and compression level among others as described herein). Such a combined dataset may serve as a foundation for predicting whether the symbols, visual elements or text will remain legible after video encoding using the first set of encoding parameters. It will be appreciated that the first set of encoding parameters and the video frame data, for example as a composite encoding parameter feature vector 128 and composite symbol feature vector 126 respectively, may be provided to the legibility classifier 112 individually or as part of any suitable composite vector or data structure thereof. Such a composite vector or data structure may be provided in any suitable manner, such as using an intermediary data combination module. Such data combination, for example using the data combination module, may include feature aggregation by assembling the extracted video frame data and encoding parameters from the respective symbol detection and tracking modules and the encoder (or any encoding parameters analysis module). In some examples, such feature aggregation may be performed per group of video frames, per video frame, per group of detected symbol or text instances, or per individual detected symbol or text instance. By combining these two sets of features into a unified vector or data structure, the system may create a comprehensive profile of the symbol or text instances, allowing the legibility classifier 112 to make a well-informed prediction regarding legibility. Each composite input vector may therefore capture a high-dimensional view of the factors affecting legibility. Through feature engineering, the system may additionally compute further derived features or visual attributes of the video frames, symbol or text instances, such as symbol or text thickness, or edge sharpness, to enhance prediction accuracy by the legibility classifier 112. Once assembled, such data may be normalized and processed to ensure consistent input quality to the legibility classifier 112.

The composite vector or data structure may be provided to the legibility classifier per group of video frames, per video frame, per group of detected symbol or text instances, or per individual detected symbol or text instance. By using this structured representation as an input to the legibility classifier 112, the classifier 112 may, at H, predict whether the video frame data and the first set of encoding parameters are expected to preserve symbol or text readability, or if modifications should be made thereto, such as in the form of metadata embedding for rendering an overlay during playback. As illustrated in FIG. 1A and FIG. 1B, in some examples the legibility classifier 112 determines a legibility of the, or each of the, detected symbol or text instances 122 based on the received composite symbol feature vector 126 and the first set of encoding parameters 128.

In the example described, the legibility classifier may comprise a binary classifier configured to determine a binary classification of either “legible” or “not legible”, based on the video frame data and the first set of encoding parameters. Any suitable binary classification algorithm will be appreciated, and several machine learning algorithms may be suitable for this task, including, but not limited to, neural networks, decision trees, and random forests. The choice of algorithm may depend on the dataset size, dimensionality, and complexity of relationships between features. For example, while decision trees and random forests can be highly interpretable, neural networks might better capture non-linear relationships in larger datasets.

For training of such a model, an annotated dataset may be used. By way of example, the training dataset may be prepared by providing video frame samples including symbols, visual elements or text of varying visual characteristics and attributes, along with corresponding sets of encoding parameters. Each video frame or segment of video frames may be annotated by a reviewer, for example a human reviewer or a computer reviewer (such as using a machine vision algorithm) configured to label symbol or text instances as “legible” or “not legible” based on their legibility after encoding and decoding for playback. Such a labeled dataset may provide a ground truth, providing such a model with examples of both legible and non-legible symbols, visual elements and text across different visual characteristic and encoding parameter combinations and scenarios. In some examples, one or more data preprocessing steps, such as normalization and outlier handling, may be used to ensure that the input training dataset is suitable for training the model.

The training process may, in some examples, involve providing the annotated training dataset (which may include an annotated combined feature vector or data structure) into the legibility classifier, and adjusting the model parameters to minimize prediction errors. Any training techniques will be appreciated, such as cross-validation and hyperparameter tuning, which may be used to enhance the generalization capability of the legibility classifier, ensuring accurate performance on unseen data. During the training, the legibility classifier may learn to map specific patterns of symbol or text characteristics and encoding parameters to a likelihood of the symbols, visual elements or text being legible following encoding and decoding for playback. For example, the legibility classifier may learn that smaller font sizes combined with low bitrate or high compression result in non-legibility or poor legibility, while larger fonts at higher bitrates may be determined to be generally legible.

Upon completion of training, the model may be deployed to process real-time or batch-processed video frame data. For each symbol or text instance, the legibility classifier may output a binary result: either “legible” or “not legible”. Such a prediction may informs a modification of the video frame data or the encoding parameters, or any combination thereof. If the symbols, visual elements or text of the video frames are deemed by the legibility classifier to be “legible”, no additional action may be required, and the video frames may proceed through a video encoding pipeline as usual. If the symbols, visual elements or text of the video frame are predicted to be “not legible”, as shown at H in FIG. 1B, modification to at least one of the video frame data or the first set of encoding parameters may be triggered. Modification of the first set of encoding parameters may, in some examples, comprise an increase or decrease of one or more of the first set of encoding parameters based on the predicted legibility, or a selection of a different parameter value for one or more of the first set of encoding parameters based on the predicted legibility. Modification of the video frame data may comprise a modification or enhancement of one or more visual characteristics of the video frames, or the determination or generation of metadata associated with the symbols, visual elements or text, the metadata configured to cause a rendered overlay of the symbols, visual elements or text over the encoded and decoded video frame during playback. As such, the system may trigger corrective measures to achieve legibility of the symbols, visual elements or text of the video frames after encoding and decoding for playback. Such modifications may, as shown in FIG. 1B, be performed by the post-prediction processor 114 configured to receive the legibility classification from the legibility classifier and output a modified version of at least one of the first encoding parameters or the video frame data. Such an approach may ensure that symbol or text legibility is maintained, even if the video frame data or first set of encoding parameters may compromise the legibility of certain symbol or text elements within the video frames.

The legibility classifier may therefore provide a streamlined and effective decision-making framework, allowing the system to adapt dynamically to various input video frame data and encoding conditions. By integrating the aggregated features of symbol or text characteristics and encoding parameters, the classifier may achieve a high degree of predictive accuracy, ensuring that essential symbol or text information remains accessible to viewers across diverse viewing contexts.

Examples will be appreciated wherein the legibility classifier may be, or comprise, a regressor configured to output a continuous metric indicating legibility, for example associated with a percentage likelihood of legibility.

In some examples, the post-prediction processor may be configured to perform the described modifications based on the legibility output, the type of symbol or text instance associated with the legibility output, or any combination thereof. For example, a particular symbol or text instance of a first type, such as comprising text characters, may provide a legibility prediction indicating non-legibility, or a legibility below a predefined legibility threshold, whereas a further symbol or text instance of a second type, such as comprising non-text information (e.g., arrows or an icon or emoji), may provide a legibility prediction indicating legibility or a legibility above a predefined legibility threshold. In some such examples, the post-prediction processor may be configured to perform a predefined modification based on the type of symbol or text instance causing the non-legibility prediction. In the described example, the modification may be selected based on modifications known to enhance legibility of text characters, and may for example comprise the identification or generation of metadata for causing a rendered overlay of the text characters over the encoded and decoded video frames during playback. Any suitable combination of modifications will be appreciated based on a type of symbol or text instance and the corresponding legibility prediction.

In some examples, such as that shown in FIG. 1B, the post-prediction processor 114 may be configured to modify the first set of encoding parameters, such as described herein, to improve the legibility of the symbol or text instances 122 in the encoded and decoded video frames for playback. The post-prediction processor 114 may be configured to output, at J, the modified encoding parameters, for receipt, at K, as an input to the legibility classifier for providing a further legibility prediction, at H or L. In the event that a negative legibility prediction is provided for the modified encoding parameters, for example at H, steps I, J and K may be repeated or iterated upon any suitable number of times until a positive legibility prediction, such as at L, is provided. It will be appreciated that, in examples wherein the legibility is provided in the form of a continuous legibility score, such as a percentage estimated legibility or percentage confidence of legibility, the output legibility may be compared with a predetermined legibility threshold. In some such examples, iteration over steps I, J and K may be performed until the output legibility meets or exceeds the predetermined legibility threshold, for example at L.

Following a positive legibility prediction, at L, of the modified encoding parameters, by the legibility classifier 112, the modified encoding parameters may be provided as input to the encoder 116, at M, for encoding the video frames 118, such as for storage or transmission.

It will be appreciated that the described components 106, 108, 110, 112, 114, 116 of the computing device 102 may be separate or combined in any suitable manner. For example, processing elements 108, 110, 112, 114, 116 of the computing device 102 may be formed as part of a single processing unit, or may be formed as discreet

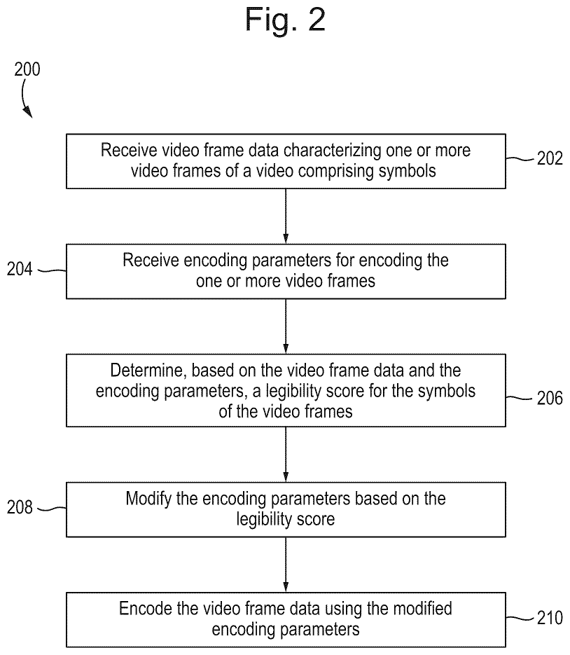

With reference to FIG. 2, a flowchart is shown representing steps of an example process 200 for providing a text or symbol legibility prediction for use in encoding one or more video frames, such as using the example system of FIG. 1A and FIG. 1B, in accordance with some examples of the disclosure. The example process 200 of FIG. 2 is performed substantially as described in relation to the system 100 of FIG. 1A and FIG. 1B. The process 200 comprises, at 202, receiving video frame data characterizing one or more video frames of a video comprising symbols. The process 200 further comprises, at 204, receiving encoding parameters for encoding the one or more video frames. The video frame data and the encoding parameters, such as the first set of encoding parameters 128 described in relation to FIG. 1A and FIG. 1B, may be received or accessed in any suitable manner, for example by way of an image capture device or an application, or by way of a memory on which the data may be stored. For example, the video frame data may be captured at an image capture device and stored at a memory. The video frame data may be accessed by way of the memory as part of the receiving of the video frame data at 202. The encoding parameters received at 204, may be accessed by way of a memory or received from an encoder, such as encoder 116 of the example system 100 of FIG. 1A and FIG. 1B. The video frame data may in some examples comprise raw video frames as captured at the image capture device, or any suitable data representing or characterizing the video frames, which may be obtained during any suitable processing of the video frames. For example, one or more visual characteristics of the video frames may be stored or communicated as a composite data structure or feature vector following a feature extraction process performed on the video frames. Such a feature extraction may be performed in any suitable manner such as described herein, for example in relation to the system 100 of FIG. 1A and FIG. 1B.

Following the receipt of the video frame data and the encoding parameters, the process 200 further comprises, at 206, determining, based on the video frame data and the encoding parameters, a legibility score for the symbols of the video frames. The legibility score may be determined in any suitable manner such as described herein. For example, a trained legibility classifier or regressor may receive the video frame data and the encoding parameters as an input, and may output a legibility score (such as a binary legibility classification, a continuous predicted legibility metric, or a structured legibility prediction) based on the input the video frame data and encoding parameters, and one or more trained parameters (such as weights and biases) of the classifier or regressor. In the case of a machine learning legibility model, the model architecture may in some examples incorporate additional components such as preprocessing componentry, hyperparameters, and memory, depending on the specific model type implemented. One or a sequence of such models may be implemented, which may include additionally intermediary processing elements therebetween. Examples of such models may include neural networks, decision trees or random forests, but any suitable additional model types will be appreciated.

The process 200 further comprises, at 208, modifying the encoding parameters based on the legibility score. Such a modification may be performed, for example, based on a negative legibility prediction or determination output at 206. Such a modification may, for example, be performed to the encoding parameters in any combination with modifications to the video frames or the video frame data. The modifications may be comprise determining or selecting alternate encoding parameters, or determining or selecting a modification, or a type of modification, to be made to the encoding parameters. The modification may, for example, be performed by a post-prediction processing module 114 as described and shown in relation to the example system 100 of FIG. 1A and FIG. 1B, or by any suitable processing device or processing element as will be appreciated.

In some examples, at 210 the process 200 further comprises encoding the video frame data using the modified encoding parameters. In some examples, the encoding of the video frames or video frame data may immediately follow the modification to the encoding parameters. In some examples, the encoding of the video frames or video frame data may be preceded by a further legibility determination performed using the modified encoding parameters, in any suitable combination with the video frames and/or the video frame data. In such examples, the encoding may follow a positive legibility determination (for example a classification of “legible” or a legibility prediction above a predetermined threshold) or prediction based on the modified encoding parameters, in any suitable combination with the video frames and/or the video frame data.

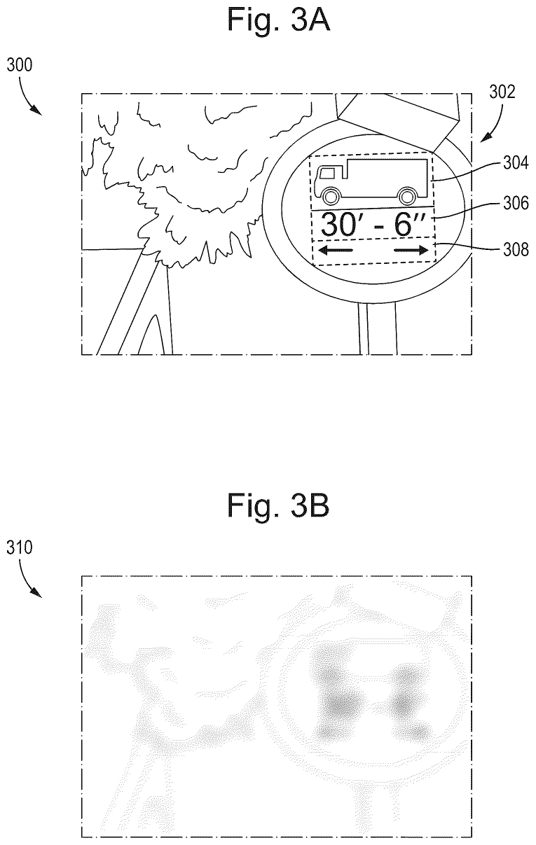

With reference to FIG. 3A, an example received video frame 300 is shown, suitable for use in accordance with the disclosure. The video frame 300 is substantially as described to have been captured by an image capture device of the vehicle 104 in the example system 100 of FIG. 1A and FIG. 1B, and depicts a road sign 302 bearing symbols, visual elements and text 304, 306, 308 indicating a vehicle length restriction. The symbols, visual elements and text of the road sign carry important informational value to road users and, for the purpose of reviewing the vehicle's journey at a later date, such as following a road traffic incident involving, or in the vicinity of, the vehicle 104, the symbols, visual elements and text of the road sign may be required to be legible on playback. The symbols of the road sign 302 detected by the symbol detection module 108 comprise an indication of a truck 304, text information detailing the length restriction 306, and arrows 308 indicating that the restriction applies to the length of the vehicle.

The video frame 300 may be part of a sequence of video frames forming a video captured during the journey of the vehicle, and passed to an encoder of the vehicle for storage in a memory thereof. As part of the encoding pipeline for the video frames including the video frame 300 shown, and in order to maintain legibility of the symbols 304, 306, 308 therein for observing during playback, a legibility prediction may be performed, such as described herein, for example the legibility prediction of FIG. 1A/1B or FIG. 2. For example, the symbols 304, 306, 308 may be detected as part of a symbol detection process, the visual characteristics thereof forming a structured feature set of video frame data characterizing the video frame, for combining with a first set of one or more encoding parameters for passing as input to a legibility prediction model. The legibility prediction model may, for example, determine or predict that, based on the first set of one or more encoding parameters and the video frame data, at least one of the symbols will not remain legible during decoding for playback, following encoding using the first set of one or more encoding parameters. The legibility prediction model may be a trained machine learning model trained using annotated sets of video frames or video frame data of road traffic footage comprising symbols, and corresponding encoding parameters.

FIG. 3B shows the decoded version 310 of the example video frame 300 of FIG. 3A when encoded using the example first set of one or more encoding parameters as described in relation to FIG. 3A. The decoded video frame 310 shows the encoding and decoding outcome of encoding the video frame 300 of FIG. 3A using the first set of encoding parameters, as may be predicted by the legibility prediction module and represented by an output legibility score thereby. As can be seen in the decoded video frame 310 of FIG. 3B, at least the text 306 indicating the vehicle length restriction are predicted to be non-legible during decoding and playback, following encoding using the first set of encoding parameters.

In some examples, the legibility prediction may be used for, or may trigger, performance of a modification to at least one of the first set of encoding parameters or to the video frames or video frame data as described herein. In some examples, the symbols 304, 306, 308 detected, such as during the symbol detection process described in relation to the symbol detection module 108 of FIG. 1B, may be used to determine or generate metadata associated therewith. The metadata may be associated with, or embedded with, the encoded video frames for storage, the metadata configured to be used by a decoder or playback device during playback for rendering an overlay of the symbols over the decoded video frame.

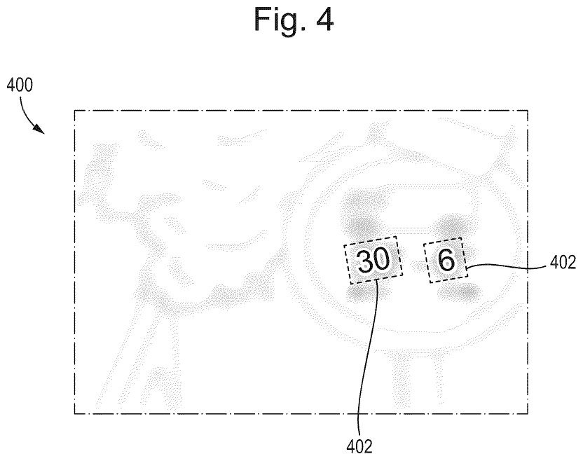

FIG. 4 shows an example modified version 400 of the video frame 300 of FIG. 3A encoded using the first set of one or more encoding parameters of FIG. 3B, and then decoded for playback, the modified version 400 including metadata associated therewith for rendering symbols 402 of the received video frame 300 of FIG. 3A during playback, in accordance with the present disclosure. As shown in FIG. 4, the rendered symbols 402 described by the metadata generated as part of the modified video frame are at least a portion of the text characters 306 describing the extent of the vehicle length restriction, such that the information intended to be conveyed thereby is legible during playback. As can be seen, the visual characteristics of the rendered symbols 402 may be associated with legibility, for example based on a resolution or bitrate thereof.

Examples will be appreciated wherein any suitable number of the symbols 304, 306, 308 detected for the road sign 302 of the video frame 300 may be caused to be rendered during playback using corresponding metadata. Examples will also be appreciated, as described herein, wherein the video frame 300, for example the detected symbols 304, 306, 308 therein, may be visually enhanced using any suitable image enhancement process, prior to encoding using the first set of encoding parameters, based on the legibility prediction. Examples will be appreciated wherein one or more of the first set of encoding parameters, such as a bitrate, resolution or compression level, may be modified or replaced based on the legibility prediction. Examples will be appreciated wherein the legibility prediction may be used to determine, based on the first set of encoding parameters, a modified quality bitrate curve for the video frame 300, for the purpose of providing a bitrate ladder for use during playback of the video frame using an adaptive bitrate technique such as adaptive bitrate streaming. Any other suitable examples comprising a modification of the video frames or video frames data, of the encoding parameters, or of any combination thereof, will be understood as described herein.

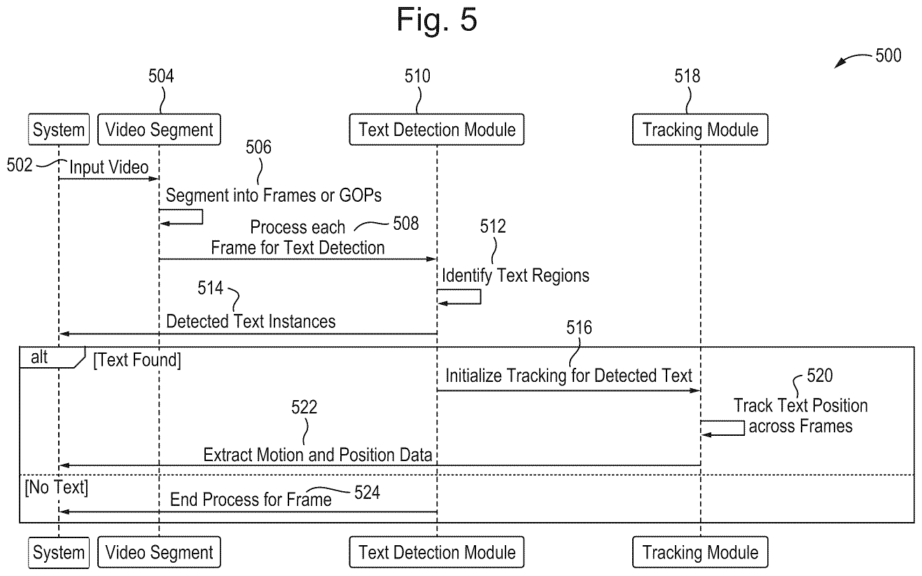

With reference to FIG. 5, a sequence diagram is shown depicting an example symbol detection and tracking process 500 such as, but not limited to, that described in relation to the symbol detection module 108 and the tracking module 110 of FIG. 1B, and suitable for performance thereby. In particular, at 502, input video frames of a video are received, for example following capture by an image capture device, at a video segmentation element 504 of a processing device for segmenting into a group of pictures (GOP). At 506, the video frames are segmented into individual frames, groups of frames or GOPs. At 508, the segmented video frames are communicated to the text detection module 510 for processing and text detection. Any suitable manner of text detection will be appreciated, such as described herein, and may for example include an OCR process. At 512, the text detection module 510 may be configured to detect regions of interest within the video frames comprising text, the regions of interest forming detected text instances. The detected text instances, at 514, may be communicated to any suitable downstream element of the system, for example the tracking module, for further processing. The text detection module 510 may be additionally configured to determine one or more visual characteristics of the detected text instances, for example for the purposes of generating a data structure of the visual characteristics or features for use as input as video frame data to a legibility prediction model.

At 516, if the number of text instances determined from a video frame is greater than zero, the tracking module 518 may be initialized to track each of the detected text instances, to be received from the text detection module 510. At 520, the tracking module 518 may perform a tracking of the detected text instances across more than one of the video frames, in any suitable manner such as described herein. At 522, the tracking module 518 may be configured to output the extracted motion and position data associated with the tracked text instances, for example as a structured data set for use as input into a legibility prediction module, optionally in any suitable combination with video frame data characterizing the video frames as described herein. At 524, in the event that no text instances are detected by the text detection module 510 for a given video frame, the text detection module 510 may be configured to end processing of the video frame.

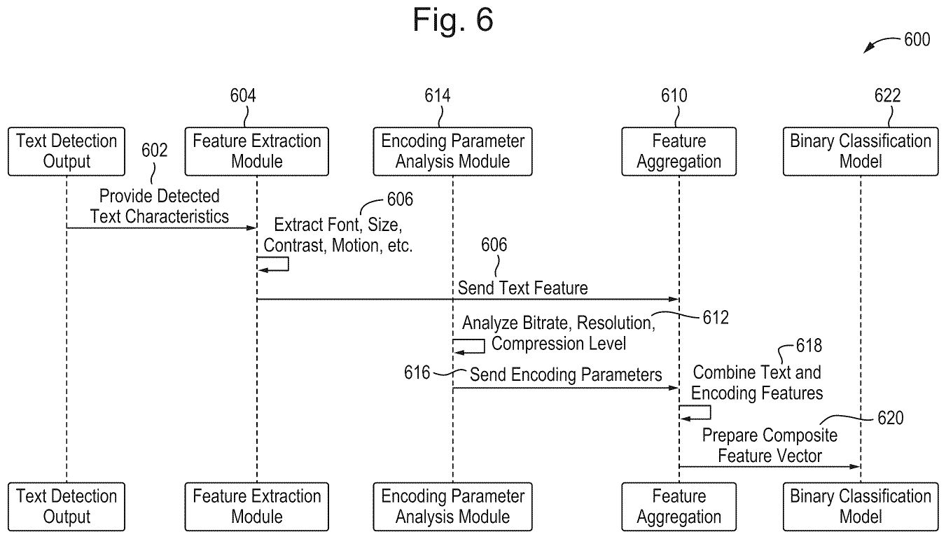

With reference to FIG. 6, a sequence diagram is shown depicting an example feature set aggregation process 600 for use in aggregating extracted features from video frames as video frame data, such as visual characteristics and tracking data associated with detected symbols, visual elements or text, for use as input to a legibility prediction model. In the example process 600 shown, feature extraction and aggregation modules may be implemented in any suitable combination. For example, at 602, detected text instances, such as characteristics associated therewith, may be communicated to a feature extraction module 604, such as from a text detection module (for example symbol detection module 108, text detection module 510) or a tracking module (for example tracking module 110, tracking module 518). The detected text characteristics may, for example, include pixel data for the detected text regions, optionally including associated position and motion data identified by the tracking module. At 606, the feature extraction module 604 may be configured to extract one or more visual characteristics of the detected text instances, such as font type, font size, contrast and motion, among others as will be appreciated, such as described herein. At 608, the feature extraction module 604 may be configured to communicate the extracted visual characteristics as text features as video frame data to a feature aggregation module 610 for collation into a composite feature set or vector. Examples will be appreciated wherein the feature extraction process may be performed by the text detection module (for example symbol detection module 108, text detection module 510). At 612, an encoding parameter analysis module 614 (for example, encoder 116) may identify, determine or analyze a first set of one or more encoding parameters, such as a bitrate, a resolution, and a compression level among others such as described herein. At 616, the encoding parameter analysis module 614 may be configured to output the first set of encoding parameters to the feature aggregation module 610 for collation into the composite feature set or vector. At 618, the feature aggregation module 610 may be configured to combine the video frame data and the first set of encoding parameters as a composite feature vector, such as suitable for input into a legibility prediction model. At 620, the feature aggregation module 610 may be configured to communicate the composite feature vector to a legibility prediction model 622 (for example, legibility classifier 112), which in the example shown is a binary classification model but others will be appreciated as described herein, for outputting a legibility prediction based on the video frame data and the encoding parameters.

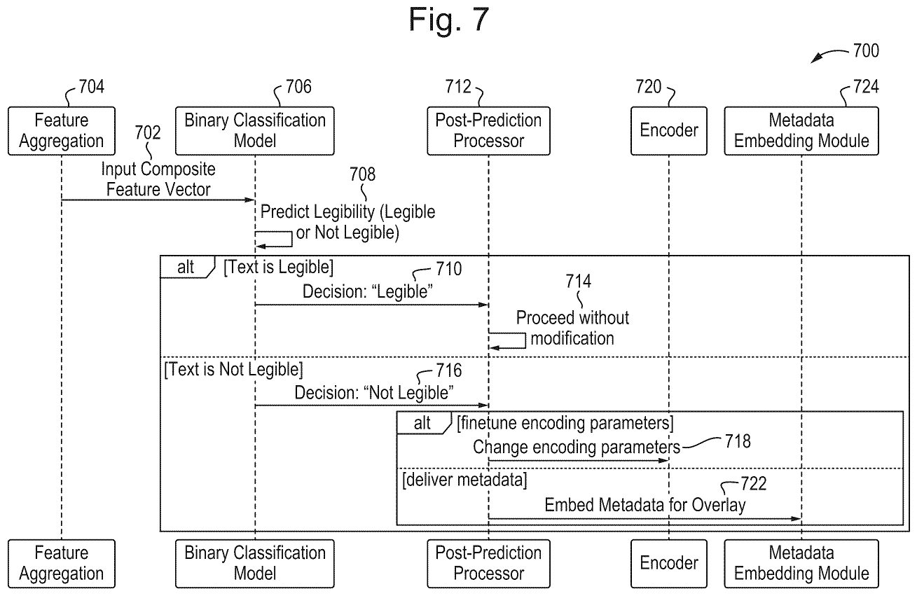

With reference to FIG. 7, a sequence diagram is shown depicting an example encoding process 700 comprising an encoding of video frames based on a legibility prediction in accordance with the present disclosure. At 702, a composite feature vector comprising video frame data and encoding parameters, such as that described in relation to FIG. 6, is communicated from a feature aggregation module 704 (for example, feature aggregation module 610) to a binary classification model 706 (for example, legibility prediction model 622). At 708, the binary classification model 706 may be configured to perform a legibility prediction based on the composite feature vector of video frame data and encoding parameters, using any suitable manner such as described herein. At 710, the legibility prediction output from the binary classification model 706 may be communicated to a post-prediction processor 712 (for example, post-prediction processor 114), which may optionally be configured to access the composite feature vector, or the video frame data and the encoding parameters individually. In particular, at 710, the binary classification model 706 may output a classification of “legible”, in which case one or more text instances characterized by the video frame data, when encoded using the encoding parameters, are predicted to be legible during decoding for playback. At 714, the post-prediction processor 712 may be configured not to initiate any modification of the video frame data or the encoding parameters. At 716, the binary classification model 706 may output a classification of “not legible”, in which case one or more text instances characterized by the video frame data, when encoded using the encoding parameters, are predicted to be non-legible during decoding for playback. At 718, following the non-legibility prediction, the post-prediction processor 712 may be configured to initiate a modification of the encoding parameters, for example by way of an encoder 720 (for example, encoder 116). At 722, following the non-legibility prediction, the post-prediction processor 712 may be configured to initiate modification of the video frame data, such as to embed metadata associated with the non-legible text instances, for rendering as an overlay during decoding and playback, by way of a metadata embedding module 724. Such a modification of the encoding parameters and a modification of the video frame data may occur individually or in any suitable combination thereof, as described herein

In the post-prediction processing phase, the system may determine the next steps for the encoding of the video frames based on the output from the legibility prediction model, for example for each detected symbol or text instance. In some examples, if the symbols, visual elements or text are predicted to be legible, no additional processing may be required, and the video segment may continue through the encoding pipeline as intended. This outcome may allow for efficient handling of segments where symbol or text legibility is predicted, or estimated to be above a legibility threshold, conserving processing resources and avoiding unnecessary modification, for example by way of encoding parameter modification or video frame data modification, such as using metadata embedding as described.

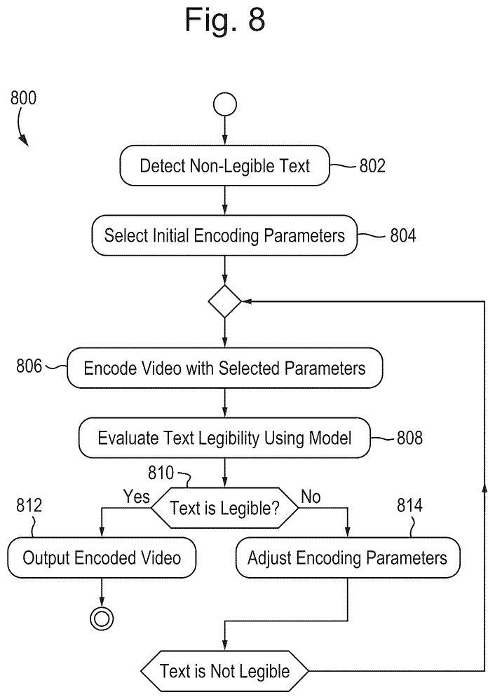

With reference to FIG. 8, a flowchart depicting steps of an example finetuning process 800 is shown for use in accordance with the present disclosure. At 802, a prediction of non-legibility of one or more detected text instances of a video frame may be received, for example from a legibility prediction model (for example, legibility classifier 112, legibility prediction model 620, binary classification model 704). At 804, an initial set of modified encoding parameters may be selected. At 806, the video frame(s) may be encoded using the selected initial set of modified encoding parameters. At 808, the legibility prediction model may be used to perform a legibility prediction of the encoded video frames. At 810, a decision step may be performed based on the output of the legibility prediction model. In particular, if the legibility prediction model output indicates that text instances within the encoded video frames are predicted to be legible, at 812, the encoded video frames may be output, for example for storage or transmission. At 814, if the legibility prediction model output indicates that text instances within the encoded video frames are predicted to be non-legible, the initial encoding parameters may be modified in any suitable manner, such as described herein, and at 806 the video frame(s) may be encoded using the modified encoding parameters for repeating the legibility assessment described, until the output from the legibility prediction model indicates that the text instances within the encoded video frames are predicted to be legible. The example of FIG. 8 depicts an alternative suitable legibility assessment workflow in which the input to a legibility predictor may be video frames encoded with one or more encoding parameters, the legibility predictor predicting a legibility of text instances within the encoded video frames. As such, in some examples use of the term “video frame data and encoding parameters” or “composite feature vector” may refer to encoded video frames.

For symbol or text instances predicted to be non-legible, systems of the present disclosure may therefore, in some examples, adaptively select a new set of encoding parameters to enhance symbol or text legibility in the output. This may, in some examples, comprise altering one or more encoding parameters, such as choosing a higher-quality encoder, increasing the bitrate, adjusting the resolution, or reducing the compression level, or even allocating more bits to the illegible symbol or text region of the video frame. In some examples, there may be a predetermined, limited or finite list of encoding parameters or parameters types for modification. In some such examples, any suitable process of determining or selecting, and modifying, one or more list entities of the list of encoding parameters or parameter types, which may be in an iterative manner, may be envisaged. In some examples, one or more of the list of encoding parameters or parameter types may be selected based on an expected, predicted or determined effect of the encoding parameters or parameter types on the legibility score of a future legibility determination. In some examples, the list of encoding parameters or parameter types may be sorted or ranked in order of an expected effect of the encoding parameters or parameter types on the legibility score of a future legibility determination. Such a selection from, or ranking of, the list of encoding parameters or parameter types may be used to determine the encoding parameter to be modified, and/or the modification thereto. In some examples therefore, an (optionally iterative) modification of one or more of the encoding parameters, for example based on a determined or estimated effect on the legibility score of a future legibility determination, may be performed.

In some examples, historic modification data may be used to perform said determination of the one or more encoding parameters to be modified and/or the modification thereto. The historic modification data may comprise, for one or more historic instances of modifying an encoding parameter or video frame data, one or more selected from: the received video frame data; the received encoding parameters; the determined legibility score; the modified video frame data; the modified encoding parameters; the determined further legibility score. For example, a known, predetermined or modeled pattern or correlation between one or more encoding parameters, encoding parameter types or encoding parameter modifications and a legibility score may be used to determine or select the encoding parameters to be modified and/or the modification to be performed. Such a determination may be performed in an iterative manner as described herein, until a positive legibility determination is performed. Any such model may be appreciated, and may for example comprise a machine learning model trained using a training dataset comprising the historic modification data.

In some examples, the list of encoding parameters or parameter types may be used to perform any suitable determination, such as by way of a binary or multidimensional search, of a set of encoding parameters, or encoding parameter modifications, estimated to yield a positive legibility determination. Such a search may in some examples be used to identify an encoding parameter modification having a lowest associated cost, such as a lowest computational resource cost, for yielding a positive legibility determination. Each modification may aim to improve clarity by preserving fine details of the symbols, visual elements or text to enhance legibility. The newly adjusted encoding parameters may be re-evaluated using a legibility predictor to confirm that the adjustments have improved symbol or text legibility.

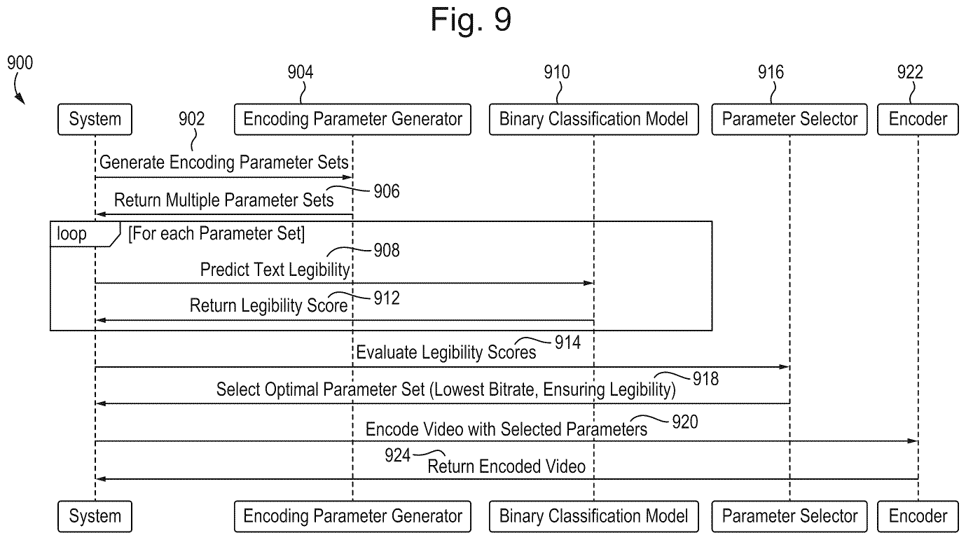

With reference to FIG. 9, a sequence diagram is shown depicting an example encoding parameter selection process 900 suitable for use in accordance with the present disclosure. At 902, sets of encoding parameters may be generated by an encoding parameter generator 904. At 906, the sets of encoding parameters may be output to any suitable element of the system for performing a text legibility prediction, for example using a legibility prediction model as described herein. For each set of the sets of encoding parameters, at 908, a legibility prediction may be performed using a binary classification model 910, using the respective set of encoding parameters and video frame data characterizing a video frame. At 912, the binary classification model 910 may output a legibility score indicating whether text instances within the video frames, based on the respective set of encoding parameters, are legible or not. At 914, a parameter selector 916 may evaluate each of the output legibility scores for each of the sets of encoding parameters, and may, at 918, select an optimal set, of the sets of encoding parameters, for example based on a lowest bitrate set which receives a legibility score indicating that symbol or text instances of the video frames remain legible during decoding and playback. At 920, an encoder 922 may be used to encode the video frames using the selected set of encoding parameters, and at 924, the encoded video may be communicated, for example for storage or transmission.

In some examples therefore, systems of the present disclosure may be configured to generate multiple encoding parameter sets, each providing different potential quality outcomes. For each set, the legibility prediction model may predict a legibility, such as legibility score, of each symbol or text instance, and based on the prediction, an optimal encoding parameter set may be selected. For example, the system may select an encoding parameter configuration with the lowest allowable bitrate which still ensures legibility of all text instances of a video frame, and may thereby optimize both quality and resource efficiency.

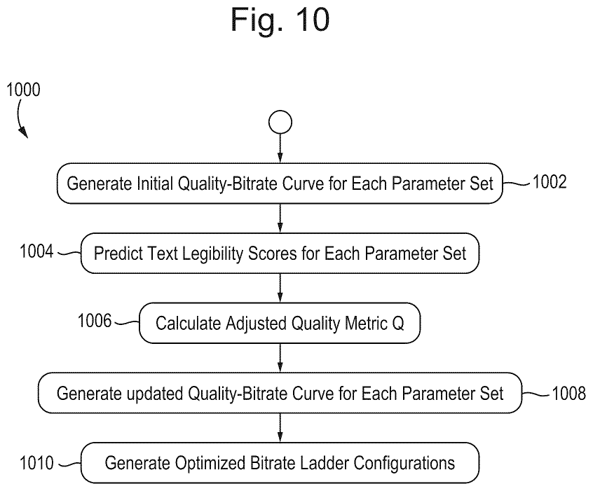

With reference to FIG. 10, a flowchart is shown depicting steps of an example process 1000 for generating optimized bitrate ladder configurations, such as for use during adaptive bitrate streaming applications. At 1002, for each of a plurality of sets of encoding parameters, a quality-bitrate curve may be generated. At 1004, a legibility score may be predicted for each of the sets of encoding parameters in combination with video frame data for one or more video frames. At 1006, an based on the predicted legibility scores, an adjusted quality metric may be calculated for use in generating an updated quality bitrate curve. At 1008, the updated quality bitrate curve may be generated for each encoding parameter set using the adjusted quality metric. Based on the updated quality bitrate curve, at 1010, a bitrate ladder configuration may be generated,

In some examples therefore, a quality-bitrate curve may be updated for each of a one or more encoding parameter configurations, which may allow systems of the present disclosure to quantitatively assess quality across potential video encoding settings. The quality metric, denoted as Q, may be refined by incorporating a symbol or text legibility measure, which may be provided as described herein. The modified quality metric Q may, in some examples, be calculated as:

Q=w1*Q_original+w2*Q_text, wherein, Q_original represents the original standard quality metric for the video frames, Q_text represents the legibility score predicted for detected text instances of the video frames, and w1 and w2 are weights configured to balance general quality and symbol or text legibility. The text legibility score Q_text may be derived as a function of individual legibility score predicted for multiple, for example each, detected symbol or text instance of a video frame.

Q_text may, in some examples, be computed as follows:

$$Q\_text = sum\_i ( W\_i * L\_i ) / sum\_i ( W\_i )$$

The system may for example calculate a weighted average across detected symbol or text instances, where each symbol or text instance i has a legibility score L_i and a weight W_i, which may be, for example, based on factors such as saliency and symbol or text bounding box size. W_i may be derived from the symbol or text box or region saliency score, or its area, giving greater priority or saliency to larger or more visually important symbol or text regions in the quality evaluation.

In some examples, this adaptive encoding process can be integrated with adaptive bitrate streaming protocols (such as DASH or HLS) to ensure consistent symbol or text legibility across different quality versions of a video stream. In some examples, each bitrate variant of an encoded one or more video frames may be optimized to maintain symbol or text legibility at its respective quality level. By embedding a predictive legibility model into adaptive bitrate streaming protocols, systems and methods of the present disclosure may dynamically adjust encoding settings based on real-time network conditions, and may deliver the best possible symbol or text legibility for varying connection speeds and devices.

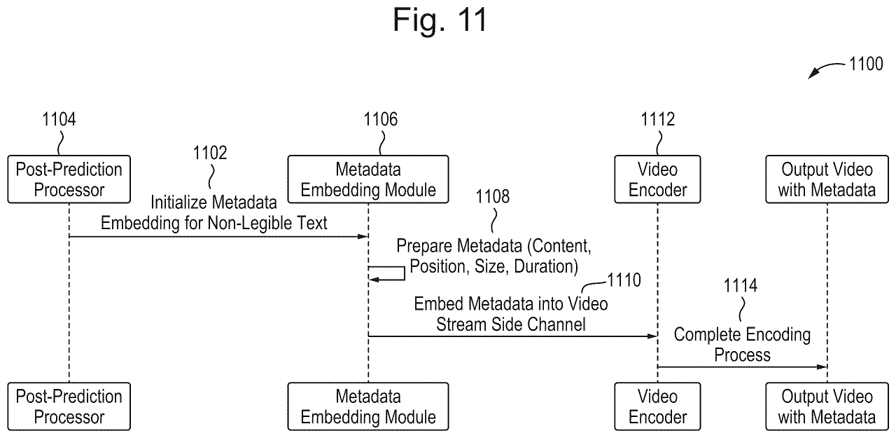

With reference to FIG. 11, a sequence diagram is shown depicting an example metadata embedding process 1100 suitable for use in accordance with the present disclosure. At 1102, a post-prediction processor 1104 (for example, post-prediction processor 114, post-prediction processor 712) may, based on a non-legibility prediction from a legibility prediction model, initialize a modification to corresponding video frame data comprising metadata embedding associated with the non-legible symbol or text instance. Such modification may be initialized by way of a metadata embedding module 1106, and at 1108, the metadata embedding module 1106 may identify or determine the metadata for preparation for the embedding, such as in accordance with one or more visual characteristics of the identified symbol or text instance (such as identified characters or content, a position a size, a duration or number of frames). At 1110, the metadata embedding module 1106 may embed the metadata into a video steam side channel for encoding at an encoder 1112. At 1114, the encoder 1112 may complete the encoding process and output the encoded video and embedded metadata for storage or transmission.

In some examples therefore, if symbol or text instances are predicted to be non-legible, systems and methods of the present disclosure may initiate a corrective action by embedding symbol or text information as metadata for storage or transmission in associated with the encoded video frames, for example within a side channel of a video stream. This metadata may act as an auxiliary source of symbol or text information which may be accessed by compatible devices or players, enabling rendering of an overlay of the symbol or text as intended, and may thereby ensure readability independent of potential video degradation resulting from the encoding process. By embedding metadata rather than directly modifying visual characteristics of the video frames, this approach may maintain the original quality and size of the encoded video frames, and may therefore maximize flexibility and player compatibility, while adding only a minimal amount of data overhead for the embedded metadata.

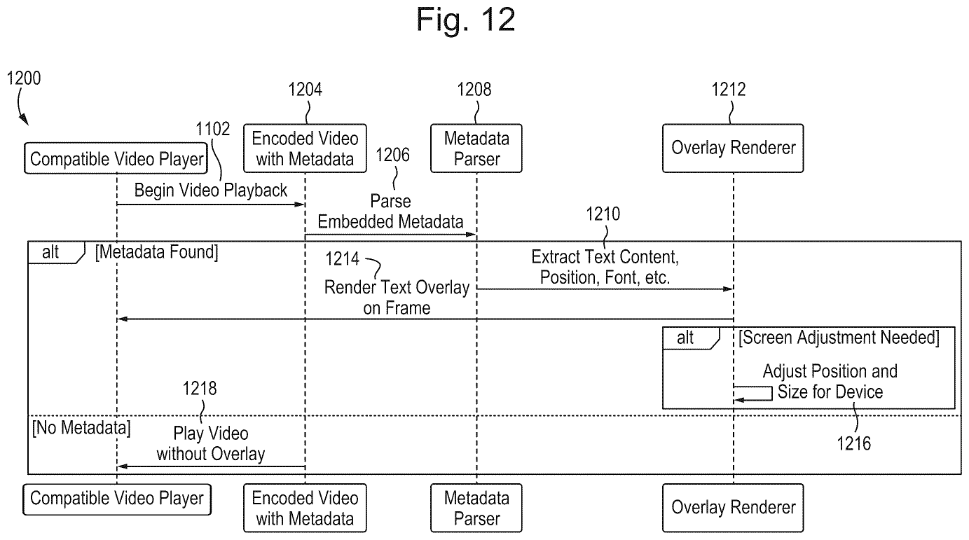

With reference to FIG. 12, a sequence diagram is shown depicting further steps of an example metadata embedding process 1200, suitable for use in accordance with the present disclosure, for example as additional steps to the process 1100 depicted in, and described in relation to FIG. 11. At 1202 a video player may access the encoded video frames with embedded metadata 1204, and at 1206 a metadata parser 1208 of the video player may parse the metadata. At 1210, in the event that metadata is found to be embedded with the encoded video frames, the metadata parser 1208 may extract features from the metadata to an overlay renderer 1212, the features configured to cause rendering of the characterized text or symbols, such as text or symbol content or characters, position, font among others as will be appreciated. At 1214, the overlay renderer 1212 may render the symbols, visual elements or text overlaid on a video frame at corresponding position and orientation and in accordance with the described text or symbol content. At 1216, the overlay renderer 1212 may perform any suitable adjustment (such as position, size, or color, among others) to the rendered overlay, for example based on display or screen settings (such as screen size, resolution, color gamut, among others) for a display device. At 1218, in the event that no metadata is identified by the metadata parser 1208, the video player may play the encoded video without a rendered overlay.

The metadata embedding process may, for example, include encoding one or more parameters associated with symbol or text rendering. For example, a content of the symbol or text may be determined, enabling accurate reproduction thereof such that the rendered overlay replicates the intended information accurately. A position of the symbol or text may be determined, such as the x-y coordinates of the symbol or text position within the video frame, which may allow the rendered overlay to match the original location of the symbol or text, preserving spatial context. A size and optionally any other suitable visual characteristics or features, such as a font, of the symbols, visual elements or text may be determined. Details such as a font type and a size, for example a size of a bounding box of an identified region of interest, may be determined to maintain visual consistency with the original appearance of the text and symbols of the video frames, which may allow the playback device to reproduce the symbols, visual elements or text in a way that blends with the design of a video. A duration of the appearance of the symbols, visual elements or text instance may be determined. For example a start and end frame number may be determined to specify when the symbol or text overlay should appear and disappear, synchronizing the overlay with the video content.

After embedding, such metadata may be encoded using the (optionally modified) encoding parameters alongside the received video frames, and may be accessible to compatible video players during decoding and playback. By using a side channel for any such metadata, the system may ensure a backward compatibility, allowing players without overlay capability to ignore the metadata without affecting video playback. For compatible players configured to interpret the embedded metadata, the playback process may include steps to parse, position, and render the symbol or text overlays accurately as described. For example, the player may be configured to read and interpret the metadata embedded with the video frames, and may in some examples identify any instructions related to non-legible symbol or text instances. A metadata parsing step may cause extracting of details such as the symbol or text content, position, font, size, and timing, and prepare such attributes for causing the overlay rendering.

Once the metadata is parsed, the player may initiate the overlay symbol or text rendering by drawing the symbol or text at the specified location within the video frame. Such rendering may in some examples match metadata specifications for one or more individual visual characteristics such as font type, style and size (among others as will be appreciated), which may ensure the overlay integrates seamlessly with the visual elements of the video frames. By adhering to any position and size instructions of the metadata, the player may maintain the visual context of the original symbols, visual elements or text, allowing display of the information as if it were part of the originally captured video.

In addition to, or as an alternative to, overlay rendering in accordance with strict visualization instructions within the metadata (such as position, orientation, font type, style, size, among others), the player may implement adaptive positioning mechanisms to account for various viewing conditions or display device settings or parameters. For example, if the video is displayed on a smaller screen or in a different orientation (for example, portrait mode on a mobile device), the player may adjust the symbol or text overlay position or orientation to prevent overlap with other user interface (UI) elements or to maintain readability. In instances wherein a display color gamut is different to, or incompatible with, color characteristics described in the metadata, the player may be configured to dynamically determine an adjusted color palette for the overlay rendering. Such adaptive capability may be beneficial for ensuring usage flexibility and compatibility, and that important visual information remains visible and legible across different screen types, sizes and orientations, enhancing accessibility and user experience.

By leveraging metadata to render adaptive symbol or text overlays, compatible players may ensure that key visual information remains clear and readable, even under challenging encoding conditions or on varied playback devices. This approach may combine the robustness of metadata-driven overlays with the flexibility needed to support diverse viewing scenarios, providing a consistent solution for maintaining text legibility across encoded video content.

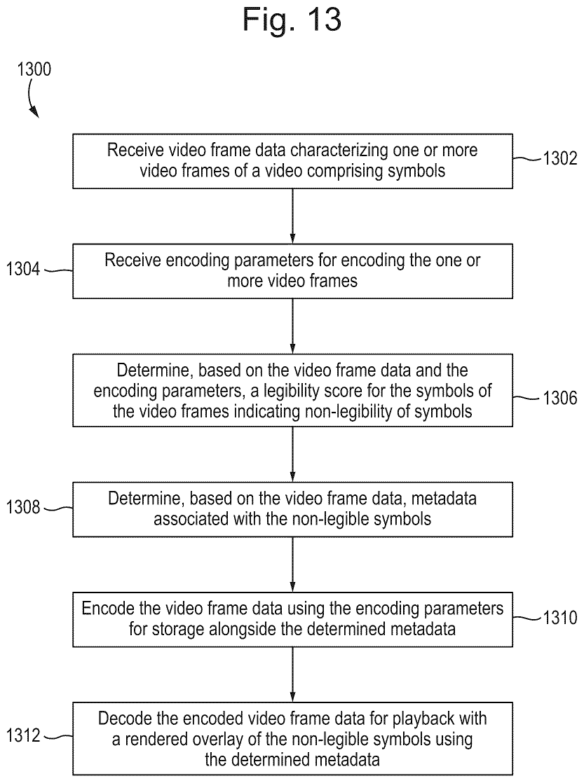

With reference to FIG. 13, a flowchart is shown depicting steps of an example method 1300 for modifying video frame data, specifically metadata, associated with video frames as part of an encoding pipeline, based on a legibility prediction in accordance with the present disclosure. At 1302, the method comprises receiving video frame data characterizing one or more video frames of a video comprising symbols. At 1304, encoding parameters are received for encoding the one or more video frames. At 1306, a legibility score for the symbols of the video frames is determined based on the video frame data and the encoding parameters, the legibility score indicating non-legibility of symbols. At 1308, metadata associated with the non-legible symbols is determined, based on the video frame data. At 1310, the video frame data is encoded using the encoding parameters for storage alongside the determined metadata, and at 1312, the encoded video frame data is decoded for playback with a rendered overlay of the non-legible symbols using the determined metadata.

The method will be understood to be performed in any suitable manner within the context of the present disclosure, for example in accordance with the example described in relation to FIG. 11 to FIG. 12.

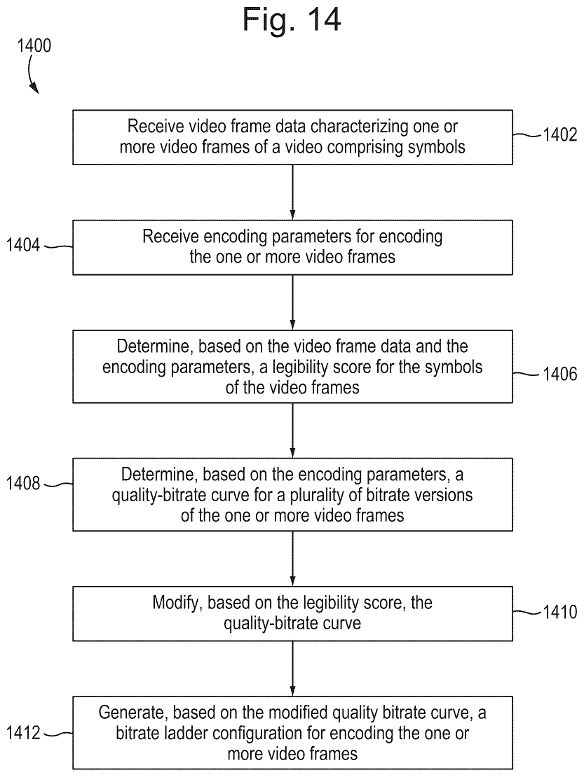

With reference to FIG. 14, a flowchart is shown depicting steps of an example method 1400 for modifying a quality-bitrate curve associated with video frames as part of an encoding pipeline, based on a legibility prediction in accordance with the present disclosure. At 1402, video frame data is received, the video frame data characterizing one or more video frames of a video comprising symbols. At 1404, encoding parameters are received, the encoding parameters for encoding the one or more video frames. At 1406, a legibility score for the symbols of the video frames is determined, based on the video frame data and the encoding parameters, a legibility score. At 1408, a quality-bitrate curve for a plurality of bitrate versions of the one or more video frames is determined. At 1410, the quality-bitrate curve is modified based on the legibility score. At 1412, a bitrate ladder configuration is generated based on the modified quality bitrate curve, for encoding the one or more video frames.

The method will be understood to be performed in any suitable manner within the context of the present disclosure, for example in accordance with the example described in relation to FIG. 10.

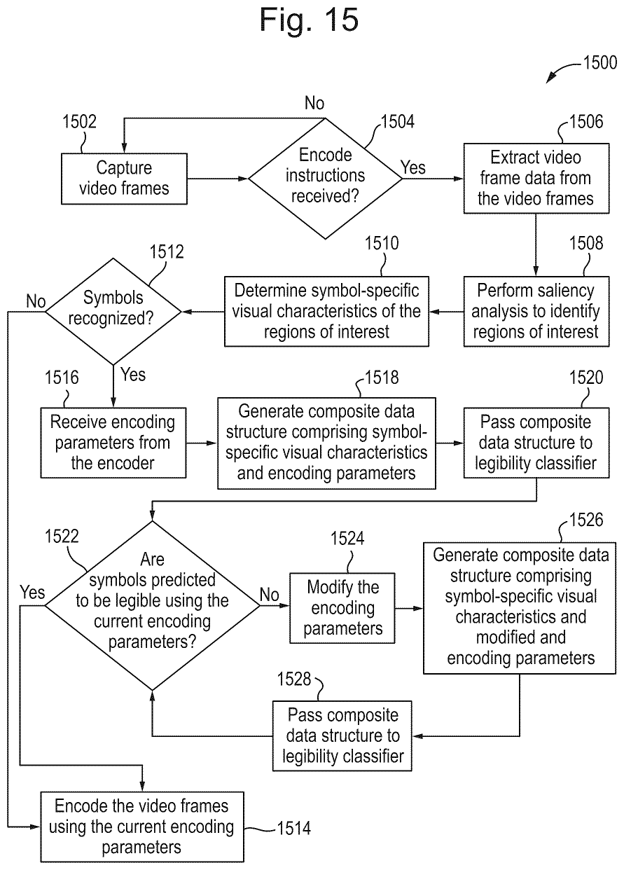

FIG. 15 shows steps of a further example process 1500 of encoding video frames based on a legibility prediction, in accordance with some examples of the present disclosure. The process 1500 comprises, at 1502, capturing one or more video frames at an image capture device. The image capture device may be any suitable image capture device, such as a vehicle camera as described in relation to the example system 100 of FIG. 1A and FIG. 1B, or an image capture apparatus of a user device, such a mobile device. The captured video frames may be received at any suitable computing device, for example for storage. At 1504, a decision step is performed wherein it is determined whether instructions are received to encode the one or more captured video frames. In the event that no instructions are received to encode the one or more captured video frames, no further steps in the encoding pipeline may be performed, and video frames may be continued to be captured by the image capture device. In the event that instructions are determined to have been received at 1504 to encode the one or more video frames, at 1506 video frame data is detected and extracted from the one or more captured video frames. The video frame data may be any suitable data characterizing the video frames, and may comprise any suitable image processing information such as pixel information or image segmentation information, tracking and motion information as described herein.

At 1508, a saliency analysis is performed on the extracted video frame data, wherein as part of the saliency analysis, regions of interest within the video frames are identified. The saliency analysis may be any suitable saliency performed based on, for example, an intended application. The saliency analysis may in some examples be based on a predetermined context, such as a semantic context associated with an intended application of the image capture and encoding, or in some examples the semantic context may be derived dynamically from the content of the video frames, and used to perform a saliency analysis to determine regions of interest within the video frames. The saliency analysis may, in some examples, determine regions of the video frames predicted to comprise symbols, visual elements or text. The saliency analysis may therefore act as a data reduction step in reducing the required data for processing in the downstream legibility prediction process.

At 1510, one or more symbol-specific visual characteristics are determined based on the regions of interest. The symbol specific visual characteristics may be any suitable characteristics associated with symbols, visual elements or text as described herein. The determining of the one or more symbol-specific visual characteristics may act as a further data reduction step, distilling the video frame data into the minimal information required of the captured video frames in order to perform a legibility prediction. The determining of the one or more symbol-specific visual characteristics will be appreciated to comprise, in some embodiments, the collating of the characteristics in a suitable data structure for downstream processing as described herein.

At 1512, a decision step is performed based on whether symbols are recognized as part of the video frames. In the event that no symbols are recognized within the video frames, no further legibility prediction is required and the video frames are encoded by the encoder at 1514 using a standard set of encoding parameters selected for the application. In the event that, at 1512, it is determined that symbols are recognized as present within the video frames based on the symbol specific visual characteristics, at 1516 one or more encoding parameters may be received by way of the encoder, the encoding parameters intended for use in encoding the captured video frames. The one or more encoding parameters may be collated in any suitable data structure for downstream processing as described herein.

At 1518, a composite data structure is generated comprising the video frame data, specifically the symbol-specific visual characteristics, and the encoding parameters. For example, respective data structures of the symbol-specific visual characteristics and the encoding parameters may be combined and formatted such that they may form a suitable composite data structure for input into a legibility prediction model. At 1520, the composite data structure is passed to a legibility classifier for performing the legibility prediction, such as described herein. The legibility classifier may, in some examples, be any suitable trained prediction model, and may be configured to output a continuous legibility metric or a structured legibility prediction.

At 1522, a decision step is performed in which it is determined by the legibility classifier, based on the composite data structure of video frame data and encoding parameters, whether the symbols of the video frames are predicted to be legible when encoded and decoded for playback using the current set of encoding parameters. In the event that the symbols are predicted to be legible using the video frame data and the current encoding parameters, at 1514, the video frames may be encoded using the current encoding parameters.

In the event that, at 1522, it is predicted that the symbols of the video frames will be illegible following encoding using the current set of encoding parameters, at 1524 the current set of encoding parameters may be modified, in any suitable manner such as described herein. At 1526, a composite data structure is generated comprising the video frame data, specifically the symbol-specific visual characteristics (for example a data structure thereof) and the modified set of encoding parameters (which replace the earlier encoding parameters as the current set of encoding parameters). At 1528, the composite data structure generated at 1526 is passed to the legibility classifier for performing a legibility prediction. In the event that the symbols of the video frames are still predicted to be illegible based on the modified encoding parameters, the encoding parameter modification process at 1524, 1526, 1528 may be repeated. In the event that the symbols of the video frames are predicted to be legible when encoded using the modified (current) encoding parameters, at 1514 the video frames are encoded using the modified (current) encoding parameters.

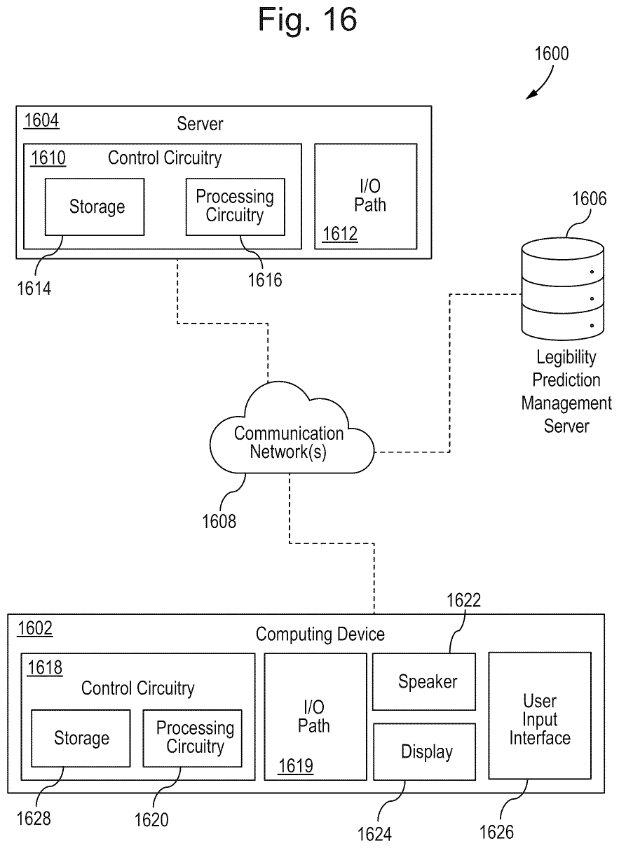

FIG. 16 is an illustrative block diagram showing example system 1600 configured to provide an encoding of video frames based on a legibility prediction process. Although FIG. 16 shows system 1600 as including a number and configuration of individual components, in some examples, any number of the components of system 1600 may be combined and/or integrated as one device, e.g., as computing device 102. System 1600 includes computing device 1602, server 1604, and legibility prediction management server 1606, each of which is communicatively coupled to communication network 1608, which may be the Internet or any other suitable network or group of networks. In some examples, system 1600 excludes servers 1604, 1606, and functionality that would otherwise be implemented by server 1604, 1606 is instead implemented by other components of system 1600, such as computing device 1602. In still other examples, server 1604, 1606 works in conjunction with computing device 1602 to implement certain functionality described herein in a distributed or cooperative manner.

Server 1604 includes control circuitry 1610 and input/output (hereinafter “I/O”) path 1612, and control circuitry 1610 includes storage 1614 and processing circuitry 1616, which may comprise imaging processing circuitry. Computing device 1602, which may be a user device such as an extended reality device for example comprising a HMD, a vehicle, a personal computer, a laptop computer, a tablet computer, a smartphone, a smart television, a smart speaker, or any other type of computing device, includes control circuitry 1618, I/O path 1619, speaker 1622, display 1624, and user input interface 1626. Control circuitry 1618 includes storage 1628 and processing circuitry 1620. Control circuitry 1610 and/or 1618 may be based on any suitable processing circuitry such as processing circuitry 1616 and/or 1620. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 1614, storage 1628, and/or storages of other components of system 1600 (e.g., storages of application database or server 1606, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid-state devices, quantum storage devices, gaming consoles, gaming media, or any other suitable fixed or removable storage devices, and/or any combination of the same. Each of storage 1614, storage 1628, and/or storages of other components of system 1600 may be used to store various types of content, metadata, and or other types of data. Non-volatile memory may also be used (e.g., to launch a boot-up routine and other instructions). Cloud-based storage may be used to supplement storages 1614, 1628 or instead of storages 1614, 1628. In some examples, control circuitry 1610 and/or 1618 executes instructions for an application stored in memory (e.g., storage 1614 and/or 1628). Specifically, control circuitry 1614 and/or 1628 may be instructed by the application to perform the functions discussed herein. In some implementations, any action performed by control circuitry 1614 and/or 1628 may be based on instructions received from the application. For example, an application may be implemented as software or a set of executable instructions that may be stored in storage 1614 and/or 1628 and executed by control circuitry 1614 and/or 1628. In some examples, the application may be a client/server application where only a client application resides on computing device 1602, and a server application resides on server 1604.

The application may be implemented using any suitable architecture. For example, it may be a stand-alone application wholly implemented on computing device 1602. In such an approach, instructions for the application are stored locally (e.g., in storage 1628), and data for use by the application is downloaded on a periodic basis (e.g., from an out-of-band feed, from an Internet resource, or using another suitable approach). Control circuitry 1618 may retrieve instructions for the application from storage 1628 and process the instructions to perform the functionality described herein. Based on the processed instructions, control circuitry 1618 may determine what action to perform when input is received from user input interface 1626.

In client/server-based examples, control circuitry 1618 may include communication circuitry suitable for communicating with an application server (e.g., server 1604) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1608). In another example of a client/server-based application, control circuitry 1618 runs a web browser that interprets web pages provided by a remote server (e.g., server 1604). For example, the remote server may store the instructions for the application in a storage device. The remote server may process the stored instructions using circuitry (e.g., control circuitry 1610) and/or generate displays. Computing device 1602 may receive the displays generated by the remote server and may display the content of the displays locally via display 1624. This way, the processing of the instructions is performed remotely (e.g., by server 1604) while the resulting displays, such as the display windows described elsewhere herein, are provided locally on computing device 1602. Computing device 1602 may receive inputs from the user via input interface 1626 and transmit those inputs to the remote server for processing and generating the corresponding displays.

A user may send instructions, e.g., to capture input data or provide input commands, to control circuitry 1610 and/or 1618 using user input interface 1626. User input interface 1626 may be any suitable user interface, such as a remote control, trackball, keypad, keyboard, touchscreen, touchpad, stylus input, joystick, voice recognition interface, gaming controller, or other user input interfaces. User input interface 1626 may be integrated with or combined with display 1624, which may be a monitor, a television, a liquid crystal display (LCD), an electronic ink display, or any other equipment suitable for displaying visual images.

Server 1604 and computing device 1602 may transmit and receive content and data via I/O path 1612 and 1619, respectively. For instance, I/O path 1612 and/or I/O path 1619 may include a communication port(s) configured to transmit and/or receive (for instance to and/or from server 1606), via communication network 1608, content item identifiers, content metadata, natural language queries, and/or other data. Control circuitry 1610, 1618 may be used to send and receive commands, requests, and other suitable data using I/O paths 1612, 1619.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

For example, while some examples described herein relate to image capture related to road traffic information associated with a vehicle journey, any suitable video frame data may be used within the present systems and methods. For example, for virtual, augmented, extended or mixed reality settings wherein one or more cameras are configured to provide a camera passthrough video feed to a head mounted display (HMD) device for viewing. Encoding of an external camera feed capturing image data of the environment in the form of video frames may be downscaled to improve latency and reaction times for updating a display screen of a HMD. As part of the downscaling, robust encoding protocols may compromise on legibility of finer details, such as symbols, visual elements or text within the environment. In some such cases, the symbols, visual elements or text within the environment may lose legibility during the downscaling process. Implementation of the present systems and methods for retaining legibility of finer details, such as symbols, visual elements or text, within a mixed reality setting may prove useful for a number of reasons. For example, the present systems and methods may enable better information transfer from an environment by way of HMD camera passthrough feed, thereby potentially reducing accidents which may result from lack of legibility of text or symbols within an environment during such applications.

Further examples will be appreciated without departing from the scope of the present disclosure. For example, one or more display specifications or settings, such as the screen size, resolution, brightness, contrast, color gamut or pixel density, or one or more viewing conditions, such as a viewing distance (for example from which a viewer is viewing the display), lighting conditions or glare, etc. Such display settings or specifications, and/or such viewing conditions, may be communicated (for example to a server) for inclusion in the input of the legibility prediction model to predict the symbol or text legibility. It will be appreciated that these additional parameters may be processed in any suitable manner such as described herein, and may be formed as part of the composite data structure provided for performing the legibility prediction.

It will be appreciated that in some examples, aspects of the process may be performed at a user device, at a server, or at any combination thereof.

While some examples herein are described as including a binary classification model, it will be appreciated that any suitable model, or combination of models, may be used, for example a legibility regression model, configured to output is a legibility score as a continuous legibility metric. In some examples, the legibility score may range from 0 to 1, or may be converted to a percentage legibility, with a higher legibility score representing a higher legibility. Any suitable actions may be taken based on the legibility score directly as described herein, or based on the comparison of the legibility score with a predetermined legibility threshold.

In some examples, after the text legibility being estimated, if a text instance is not legible or less legible, before encoding, the system can adaptively apply image enhancement techniques specifically to the text regions predicted to become illegible. This includes increasing contrast, sharpening edges, or slightly enlarging the text within the frames to improve legibility post-encoding.

In some examples, the present systems and methods may assign different levels of importance to symbols, visual elements or text based on a determined context or metadata (e.g., safety warnings, subtitles, or metadata labels or tags). Such information may be used as part of a saliency evaluation for performing data reduction, reducing the amount of information required to be processed during the legibility prediction. In some examples, gradations of stringency may be applied to different regions of interest. For example, such a saliency evaluation may be used to determine regions of a video frame having an interest level of a range of interest levels. In some such examples, a legibility prediction may apply a more stringent legibility classification, or legibility threshold, to detected symbol or text instances which are determined during such a saliency evaluation as of higher interest, and contrastingly a less stringent legibility classification, or legibility threshold, to detected symbol or text instances which are determined during such a saliency evaluation as of low or lower interest. By prioritizing the legibility assessment to regions based on a determined level of saliency or interest of that region, the present systems and methods may, in some examples, optimize resource usage during the encoding process. In some examples, visual saliency models may be used to determine which text elements are most likely to attract viewer attention and prioritize legibility preservation efforts accordingly.

In some examples, if symbols, visual elements or text is predicted to be illegible, the present systems and methods may be configured to automatically replace one or more visual characteristics, such as the font, with one that is more compression-friendly, or by automatically adjusting styling properties (e.g., boldness, italics, character or line spacing) before encoding, while maintaining an overall aesthetic consistency.

In some examples, an ensemble of predictive models may be used, each optimized for corresponding scenarios or content types (e.g., animated text, scrolling text), and the legibility prediction outputs thereof may be combined or summarized for a more accurate prediction.

1. A method of maintaining legibility of a symbol in one or more decoded video frames, the method comprising:
receiving, using control circuitry, video frame data characterizing one or more video frames of a video that depicts the symbol;
receiving, using control circuitry, one or more encoding parameters for encoding the one or more video frames;
predicting, using control circuitry, based on the received video frame data and the one or more encoding parameters, a legibility score for the symbol in the one or more video frames, the legibility score indicating a legibility of the symbol when the one or more video frames are encoded using the one or more encoding parameters and then decoded for rendering; and
based on the predicted legibility score, modifying, using control circuitry, at least one of the video frame data or the encoding parameters.

2. The method as claimed in claim 1, wherein the modifying the received video frame data or the encoding parameters comprises:
determining, based on the legibility score, a plurality of sets of modified encoding parameters;
determining, based on the received video frame data and the plurality of sets of modified encoding parameters, one or more further legibility scores for the symbol in the one or more video frames; and
selecting, based on the further legibility scores, one or more sets of the plurality of sets of modified encoding parameters for encoding the one or more video frames.

3. The method as claimed in claim 1, wherein the modifying the received video frame data or the encoding parameters comprises:
determining, based at least in part on the encoding parameters, a quality-bitrate curve for a plurality of bitrate versions of the one or more video frames;
modifying, based on the legibility score, the quality-bitrate curve; and
generating, based on the modified quality bitrate curve, a bitrate ladder configuration for encoding the one or more video frames.

4. The method as claimed in claim 1, wherein the modifying the received video frame data or the encoding parameters comprises:
determining, based on the video frame data, metadata associated with the symbol in the one or more video frames, the metadata configured to cause rendering of a recreation of the symbol overlaid over the symbol in the one or more video frames when the encoded one or more video frames are decoded.

5. The method as claimed in claim 1, further comprising:
encoding the one or more video frames based on the modified video frame data or the modified encoding parameters.

6. The method as claimed in claim 1, further comprising:
determining, based on the video frame data, one or more regions of interest within the one or more video frames, the one or more regions of interest comprising the symbol; and
determining, based on a saliency analysis of the one or more regions of interest, one or more salient regions of interest;
wherein predicting the legibility score is based at least in part on the one or more salient regions of interest.

7. The method as claimed in claim 1, further comprising:
determining, based on the video frame data, one or more symbol-specific visual characteristics;
wherein predicting the legibility score is based at least in part on the one or more symbol-specific visual characteristics.

8. The method as claimed in claim 1, wherein the symbol comprises text.

9. The method as claimed in claim 1, wherein predicting the legibility score comprises:
processing, using a predictive model, the video frame data and the one or more encoding parameters; and
outputting, using the predictive model, the legibility score.

10. The method as claimed in claim 9, wherein the predictive model is a machine learning model trained using a labelled training dataset, the training dataset comprising: a plurality of video frames comprising symbols; a corresponding set of encoding parameters for each of the plurality of video frames; and a predetermined legibility score for each of the plurality video frames.

11. A system for maintaining legibility of a symbol in one or more decoded video frames, the system comprising:
control circuitry configured to:
receive video frame data characterizing one or more video frames of a video that depicts the symbol;
receive one or more encoding parameters for encoding the one or more video frames;
predict, based on the received video frame data and the one or more encoding parameters, a legibility score for the symbol in the one or more video frames, the legibility score indicating a legibility of the symbol when the one or more video frames are encoded using the one or more encoding parameters and then decoded for rendering; and
based on the predicted legibility score, modify at least one of the video frame data or the encoding parameters.

12. The system as claimed in claim 11, wherein the control circuitry is configured to modify the received video frame data or the encoding parameters by:
determining, based on the legibility score, a plurality of sets of modified encoding parameters;
determining, based on the received video frame data and the plurality of sets of modified encoding parameters, one or more further legibility scores for the symbol in the one or more video frames; and
selecting, based on the further legibility scores, one or more sets of the plurality of sets of modified encoding parameters for encoding the one or more video frames.

13. The system as claimed in claim 11, wherein the control circuitry is configured to modify the received video frame data or the encoding parameters by:
determining, based at least in part on the encoding parameters, a quality-bitrate curve for a plurality of bitrate versions of the one or more video frames;
modifying, based on the legibility score, the quality-bitrate curve; and
generating, based on the modified quality bitrate curve, a bitrate ladder configuration for encoding the one or more video frames.

14. The system as claimed in claim 11, wherein the control circuitry is configured to modify the received video frame data or the encoding parameters by:
determining, based on the video frame data, metadata associated with the symbol in the one or more video frames, the metadata configured to cause rendering of a recreation of the symbol overlaid over the symbol in the one or more video frames when the encoded one or more video frames are decoded.

15. The system as claimed in claim 11, wherein the control circuitry is further configured to:
encode the one or more video frames based on the modified video frame data or the modified encoding parameters.

16. The system as claimed in claim 11, wherein the control circuitry is further configured to:
determine, based on the video frame data, one or more regions of interest within the one or more video frames, the one or more regions of interest comprising the symbol; and
determine, based on a saliency analysis of the one or more regions of interest, one or more salient regions of interest;
wherein predicting the legibility score is based at least in part on the one or more salient regions of interest.

17. The system as claimed in claim 11, wherein the control circuitry is further configured to:
determine, based on the video frame data, one or more symbol-specific visual characteristics;
wherein predicting the legibility score is based at least in part on the one or more symbol-specific visual characteristics.

18. The system as claimed in claim 11, wherein the symbol comprises text.

19. The system as claimed in claim 11, wherein the control circuitry is configured to predict the legibility score by:
processing, using a predictive model, the video frame data and the one or more encoding parameters; and
outputting, using the predictive model, the legibility score.

20. The system as claimed in claim 19, wherein the predictive model is a machine learning model trained using a labelled training dataset, the training dataset comprising: a plurality of video frames comprising symbols; a corresponding set of encoding parameters for each of the plurality of video frames; and a predetermined legibility score for each of the plurality video frames.

21-50. (canceled)
